(19) United States
(12) Patent Application Publication
(10) Pub. No.: US 2021/0301228 A1
(43) Pub. Date: Sep. 30, 2021

(54) Apparatus And Process For Production Of A Water-Soluble Shell, And Washing Or Cleansing Agent Portion Packs Comprising Said Water-Soluble Shell And Containing A Viscoelastic, Solid Filling Substance

(71) Applicant: Henkel AG & Co. KGaA, Duesseldorf (DE)

(72) Inventors: Matthias Sunder, Duesseldorf (DE); Peter Schmiedel, Duesseldorf (DE); Mareile Job, Leverkusen (DE); Boray Torun, Duesseldorf (DE); Katja Gerhards, Duesseldorf (DE); Steffen Ristau, Duesseldorf (DE); Thomas Weber, Weimar (Lahn) (DE); Maria Trinchera, Huerth (DE)

(21) Appl. No.: 17/347,276

(22) Filed: Jun. 14, 2021

Related U.S. Application Data
(63) Continuation of application No. PCT/EP2019/083343, filed on Dec. 2, 2019.

(30) Foreign Application Priority Data
Dec. 13, 2018 (DE) 102018221671.1

(51) Int. Cl. C11D 17/04; C11D 13/16

(52) U.S. Cl. CPC C11D 17/045; C11D 13/16

(57) ABSTRACT

An apparatus for production of a water-soluble shell for holding a filling substance, having a tank filled with a melt of a shell material, wherein the shell material contains a polymer and is water-soluble and is solid under standard conditions, and a male mold movably arranged in the region of the tank and automatically lowerable into the melt and withdrawable from the tank in order to form a water-soluble shell. The invention also relates to a corresponding process and to a corresponding shell and to a corresponding portion pack for use as a washing or cleaning agent.

### FIELD OF THE INVENTION

The invention relates to a process for production of a water-soluble shell and/or a water-soluble washing or cleaning agent portion pack.

### BACKGROUND OF THE INVENTION

Water-soluble metering units are known, for example, from EP 2 102 326 A1. Such a washing or cleaning agent portion pack comprises a first metering unit having a completely closed water-soluble container made of a transparent or translucent, polymeric material and a first washing or cleaning agent preparation enclosed in the container.

Such a portion pack contains a filling substance which, as a rule, comprises one or more than one active ingredient.

In the scope of this patent application, an active ingredient is understood to be a chemical compound other than water which (possibly in conjunction with other ingredients of a washing or cleaning agent) achieves an effect on a substrate surface, in particular on textile surfaces or hard surfaces (such as dishes). Such effects are in particular a cleaning effect, a care effect, a protective effect, or mixtures thereof.

The production of the above-mentioned metering units or portion packs is often associated with considerable effort. In the production process of the above-mentioned washing or cleaning agent portion packs, water-soluble films are generally used as the shell material. The apparatus used for production processes the above-mentioned water-soluble film and has deep-drawing chambers in which said water-soluble film is drawn into a desired shape. The film can be damaged in the process, and modifications to the shell geometry are only possible by providing alternative deep-drawing chambers, which requires considerable costs and manufacturing effort. In a further step, the filling substance of the portion pack is usually placed in the hollow shape of the deep-drawn film and this ensemble is sealed with a further water-soluble film while retaining the portion pack.

Washing or cleaning agent portion packs are also known from WO 02/06431 A2, the filling substance of which is encased in shells made of cast shell material. The shell material can be created by filling the flowable shell material into an open die and removing the excess mass from the die. In this case, an optionally cooled male mold can press the shell material against the walls of the die, whereby a hollow form is produced which functions as a shell for the portion pack.

In addition to the production-related tasks, the washing or cleaning agent portion packs must have good dissolving or dispersing power in an aqueous washing or rinsing liquor and provide good cleaning performance on the substrate when used, in particular when used in a washing machine or dishwasher. Furthermore, the filling substance of the portion pack should be packaged in the shell in such a way that the filling substance is firmly present in the hollow shape of the shell and thus cannot escape.

The object of the present invention is to create an apparatus and a process in which a simplified production of water-soluble shells and of water-soluble washing or cleaning agent portion packs containing the above-mentioned shells is made possible. The resulting shells, or the washing or cleaning agent portion packs according to the invention, should each dissolve well in water, in particular when used in a washing machine for textiles (preferably when metered into the drum of the washing machine for textiles) or a dishwasher. The filling substance should be firmly adhered to the shell of the portion pack and not leak out.

The aforementioned objects are achieved with an apparatus for production of a water-soluble shell for holding a filling substance and by a process for production of the water-soluble shell, as well as by portion packs for use as a washing or cleaning agent. The claims indicate advantageous further developments of the invention.

The invention provides an apparatus for production of a water-soluble shell for holding a filling substance, comprising a tank filled with a melt of a shell material, wherein the shell material contains a polymer and is water-soluble and is solid under standard conditions, and a male mold movably arranged in the region of the tank and automatically lowerable into the melt and withdrawable from the tank in order to form a water-soluble and solid shell (preferably adjacent to the stamp) from the shell material.

A substance (e.g., a composition) is liquid according to the definition of the invention if it is in the liquid physical state at 20° C. and 1013 mbar.

A substance (e.g., a composition) is solid or solidified according to the definition of the invention if it is in the solid physical state at 20° C. and 1013 mbar.

As is known, and therefore according the invention, a substance (e.g., a composition) is viscoelastic and solid when the storage modulus of the substance is greater than the present loss modulus at 20° C. When mechanical forces are applied to the substance, it has the properties of an elastic solid, and also exhibits a viscosity similar to that of a liquid. The termini of the storage modulus and loss modulus, and of the determination of the values of these moduli, are well known to a person skilled in the art (cf. Christopher W. Macosco, “Rheology Principles, Measurements and Applications,” VCH, 1994, page 121 et seq. or Gebhard Schramm, “Einführung in die Rheologie and Rheometrie,” Karlsruhe, 1995, page 156 et seq. or WO 02/086074 A1, page 2, third paragraph to page 4, end of the first paragraph).

In the scope of this invention, the rheological characterization is carried out by means of a rotational rheometer, for example type AR G2 from TA-Instruments or “Kinexus” from Malvern, using a cone-plate measuring system with a 40 mm diameter and 2° opening angle at a temperature of 20° C. The above-mentioned rheometer is a shear stress controlled rheometer. However, the determination can also be carried out using other instruments or measurement geometries of comparable specifications.

The measurement of the storage modulus (abbreviation: G′) and of the loss modulus (abbreviation: G″) (the unit in each case was Pa) is taken using the above-described equipment in an experiment involving oscillating deformation. For this purpose, the linear viscoelastic region is first determined in a stress sweep experiment. In this case, the shear stress amplitude is increased at a constant frequency of, for example, 1 Hz. The moduli G′ and G″ are plotted in a log-log plot. Either the shear stress amplitude or the (resulting) deformation amplitude can be plotted on the x axis. The storage modulus G′ is constant below a certain shear stress amplitude or deformation amplitude, above which it collapses. The break point is expediently determined by applying tangents to the two portions of the curve. The corresponding deformation amplitude or shear stress amplitude is usually referred to as “critical deformation” or “critical shear stress.”

In order to determine the frequency dependence of the moduli, a frequency ramp, e.g. between 0.01 Hz and 10 Hz, is performed at a constant deformation amplitude. The deformation amplitude has to be selected such that it is within the linear range, i.e. below the above-mentioned critical deformation. In the case of the filling substance according to the invention, a deformation amplitude of 0.1% has been found to be suitable. The moduli G′ and G″ are plotted against the frequency in a log-log plot.

“Standard conditions” are understood to mean ambient conditions with regard to temperature and pressure occurring in everyday life, for example temperatures in the range from 0° C. to 45° C., in particular 15° C. to 30° C., preferably 20° C. to 25° C. and an air pressure of approximately 0.9 atm to 1.1 atm in each case. Unless explicitly defined differently below, parameters which must explicitly be met in the scope of this invention under standard conditions must be met for all everyday ambient conditions with regard to temperature and pressure, in particular for the stated temperature and pressure ranges.

A substance is water-soluble if at least 0.1 g of the substance dissolves in 100 mL of distilled water at 20° C.

The water solubility of the shell material can be determined with the aid of a cuboid piece of the above-mentioned shell material (produced from the melt of the shell material in a silicone mold; weighed in a rectangular metal frame before fixing) with edge lengths in mm of 60×22×2, which cuboid piece is fixed (long edge of said frame parallel to the long edge of the cover material) in the center of said frame (edge lengths on the inside in mm: 33×22, thickness: 3 mm; outside in mm: 52×42, thickness: 2 mm), according to the following measurement protocol. The above-mentioned framed, rectangular shell material is submerged into 800 ml distilled water, temperature-controlled to 20° C., in a 1 liter beaker with a circular base (Schott, Mainz, beaker glass 1000 ml, low shape), so that the surface of the tensioned shell material is arranged at a right angle to the base of the beaker glass, the upper edge (shorter edge) of the frame is 2 cm below the water surface, and the lower edge of the frame (shorter edge) is oriented in parallel with the base of the beaker glass such that the lower edge of the frame extends along the diameter of the base of the beaker glass and the center of the lower edge of the frame is arranged above the center of the diameter of the beaker glass bottom. The shell material should dissolve with stirring (stirring speed, magnetic stirrer 400 rpm, stirring rod: 6.8 cm long, diameter 10 mm) within 6000 seconds in such a way that the gravimetrically determined residue mass of the shell material immediately filtered out (folded filter paper (medium-fast): diameter: 185 mm, thickness: 0.18 mm, weight: 85 g/m², filtration Herzberg [s]: 155 (variety 597, Hahnemühle)) of the aqueous phase after the measurement and after drying (120 minutes at 50° C. in a drying cabinet) is less than 30 wt. % based on the weight of the rectangular starting shell material. The mean value from 5 experiments is formed (arithmetic mean). Since the shell material is water-soluble, the shell formed from this shell material is also considered to be water-soluble.

A chemical compound is an organic compound if the molecule of the chemical compound contains at least one covalent bond between carbon and hydrogen. This definition applies, mutatis mutandis, to, inter alia, “organic solvent” as the chemical compound.

By implication from the definition of an organic compound, a chemical compound is an inorganic compound if the molecule of the chemical compound does not contain a covalent bond between carbon and hydrogen.

The person skilled in the art understands a polymer to be a macromolecule which, in the molecular structure thereof, contains at least ten repeating units (repetition units) which have been formed by the polyreaction of at least one monomer. According to the present invention, polymers have an average molar mass of at least 800 g/mol. A monomer is a set of molecules with the same molecular structure which, through polyreaction, can form a macromolecule that contains repeating units formed from the monomer. A homopolymer is a polymer formed from a monomer. A copolymer is a polymer formed from at least two different monomers. A polyreaction is a process for converting at least one monomer into polymers.

The average molar masses specified for polymers and/or polymeric ingredients in the scope of this application are always, unless explicitly stated otherwise, weight-average molar masses M_{w}, which can in principle be determined by means of gel permeation chromatography using an RI detector, it being expedient for the measurement to be carried out as per an external standard.

Within the meaning of the invention, a surfactant-containing liquor is a liquid preparation for treating a substrate that can be obtained by using a surfactant-containing agent which has been diluted with at least one solvent (preferably water). Hard surfaces (such as dishes) or fabrics or textiles (such as clothing), for example, are considered as the substrate. The portion packs according to the invention are preferably used to provide a surfactant-containing liquor for mechanical cleaning processes, as are carried out, for example, by a dishwasher or a washing machine for textiles.

“At least one,” as used herein, refers to 1, 2, 3, 4, 5, 6, 7, 8, 9 or more. In connection with components of the compositions described herein, this information does not refer to the absolute amount of molecules, but to the type of the component. “At least one inorganic base” is therefore understood to mean, for example, one or more different inorganic bases, i.e. one or more different types of inorganic bases. Together with stated amounts, the amounts stated refer to the total amount of the correspondingly designated type of component.

If, in the context of the application, numerical ranges are defined from one number to another number, the limit values are included in the range.

If, in the scope of the application, numerical ranges are defined between one number and another number, the limit values are not included in the range.

The apparatus necessarily comprises at least one tank which is filled with a melt of a shell material. The shell material is water-soluble and solid under standard conditions. For the production of the melt from the shell material, it has been found to be preferred if the ingredients of the shell material which are solid under standard conditions are present in powder form before melting. In a preferred embodiment, the ingredients of the shell material which are solid under standard conditions are therefore comminuted prior to melting in such a way that a powder is present with an average particle size X_{50.3} (volume average) of less than 100 μm, preferably less than 60 μm, particularly preferably less than 30 μm, in order to provide the melt. The melt is then produced from it.

Said particle sizes can be determined by sieving or by means of a Camsizer particle size analyzer from the company Retsch.

The above-mentioned melt in the tank of the apparatus preferably has a temperature of at least 60° C., more preferably at least 70° C., more preferably at least 80° C., particularly preferably at least 100° C., very particularly preferably at least 110° C., before the male mold is immersed.

The melt of the shell material should solidify within the shortest possible time. Long solidification times would result in long production time and thus lead to high costs. According to the invention, “solidification time” is understood to mean the period of time during which the shell material changes from a flowable state to a dimensionally stable state which is non-flowable at room temperature during production. Room temperature is to be understood as a temperature of 20° C. Without constituting a restriction, this can be done through the crosslinking of the at least one polymer.

Furthermore, the shell material must be storage stable under normal storage conditions. The shell material according to the invention formed into a shell is a component of a portion pack of a washing or cleaning agent. Washing or cleaning agents are usually stored for a specific period of time in a household. They are usually stored near the washing machine or dishwasher. The shell material should be stable for such storage. Therefore, the shell should be stable, in particular after a storage period of 4 to 12 weeks, in particular 10 to 12 weeks or longer at a temperature of up to 40° C., particularly at 30° C., in particular at 25° C. or at 20° C., and should not deform or otherwise change in consistency during this time.

Visually, the surface of the shell should stand out, for example, by its smoothness or a pronounced gloss.

For an optimized dissolution rate, the shell preferably has a wall thickness in the range from 150 to 3000 in particular from 200 to 1000 μm.

A change in volume or shrinkage of the shell during storage would be disadvantageous since this would result in poor consumer acceptance of the portion pack. An escape of liquid during the production of the portion pack or the exudation of constituents from the shell is also undesirable. Here, too, the visual impression is relevant, for one. The stability of the shell can be influenced by the leakage of liquid, such as solvents, such that the components are no longer stably contained and the washing or cleaning effect of the portion pack comprising the shell can also be influenced as a result.

It is also possible for the filling substance and the shell to be in direct contact with one another. In this case there should be no negative interaction between the filling substance and the shell. What is understood by “no negative interaction” in this case is that, for example, no ingredients or solvents change from the filling substance to the shell or that the stability, in particular storage stability, preferably for 4 weeks and at a storage temperature of 30° C., and/or the aesthetics of the product are not impaired in any way, for example through a change in color, the formation of wet-looking edges, or the like.

Surprisingly, it has been found that an especially high level of storage stability is achieved if the shell material of the shell is low in water. Within the meaning of the present invention, “low in water” is understood to mean that small quantities of water can be used for production of the shell. The proportion of water in the shell material of the shell and in the melt thereof is in particular 20 wt. % or less, preferably 15 wt. % or less, particularly 12 wt. % or less, in particular between 10 and 5 wt. %. The quantities in wt. % refer to the total weight of the shell. This has the advantage that the small amounts of water in combination with the at least one polymer contained in the shell material of the shell (in particular in the case of PVOH and gelatin) can have a structure- or gel-forming effect.

According to a further embodiment, the shell is substantially free of water. This means that the shell material is preferably substantially free of water. “Substantially free” is understood to mean, in this case, that the shell may contain small quantities of water. For example, this water can be introduced into the shell by means of a solvent or as water of crystallization or as a result of reactions of components of the shell material with each other. However, for production of the shell, water is not introduced as a solvent. In this embodiment, the proportion of water in the shell material and in the melt thereof is 4.9 wt. % or less, 4 wt. % or less, preferably 2 wt. % or less, in particular 1 wt. % or less, particularly 0.5 wt. % or less, in particular 0.1 wt. % or 0.05 wt. % or less. The quantities in wt. % refer to the total weight of the shell.

The shell material and the melt thereof necessarily contain at least one polymer. According to the invention, the shell material of the shell and the melt thereof can have one, two, or more polymers that differ from one another.

Polymers for use in the above-mentioned shell material include in particular (optionally acetalized) polyvinyl alcohol (PVOH), copolymers of polyvinyl alcohol, polyvinyl pyrrolidone, polyethylene oxide, gelatin, cellulose and the derivatives thereof, acrylic acid-containing polymers, polyacrylamides, oxazoline polymers, polystyrene sulfonates, polyurethanes, polyesters, polyethers and mixtures thereof, more preferably (optionally acetalized) polyvinyl alcohol (PVOH), copolymers of polyvinyl alcohol, polyethylene oxide, gelatin, and mixtures thereof.

One or more material(s) from the following exemplary, but non-limiting list can be named with particular advantage:
mixtures of 50 to 100% polyvinyl alcohol or poly(vinyl alcohol-co-vinyl acetate) with molecular weights in the range from 10,000 to 200,000 g/mol and acetate contents from 0 to 30 mol %; these can contain processing additives such as plasticizers (glycerin, sorbitol, water, PEG, etc.), lubricants (stearic acid and other mono-, di- and tricarboxylic acids), so-called “slip agents” (e.g., “Aerosil”), organic and inorganic pigments, salts, blow molding agents (citric acid-sodium bicarbonate mixtures);
acrylic acid-containing polymers, such as, for example, copolymers, terpolymers or tetrapolymers which contain at least 20% acrylic acid and have a molecular weight of 5,000 to 500,000 g/mol; particularly preferred comonomers are acrylic acid esters such as ethyl acrylate, methyl acrylate, hydroxyethyl acrylate, ethylhexyl acrylate, butyl acrylate, and salts of acrylic acid such as sodium acrylate, methacrylic acid and the salts and esters thereof such as methyl methacrylate, ethyl methacrylate, trimethylammonium methyl methacrylate chloride (TMAEMC), methacrylate amidopropyl trimethylammonium chloride (MAPTAC). Further monomers such as acrylamide, styrene, vinyl acetate, maleic anhydride, vinyl pyrrolidone can advantageously also be used;
polyalkylene oxides, preferably polyethylene oxides with molecular weights of 600 to 100,000 g/mol and their derivatives modified by graft copolymerization with monomers such as vinyl acetate, acrylic acid and the salts and esters thereof, methacrylic acid and the salts and esters thereof, acrylamide, styrene, styrene sulfonate, and vinyl pyrrolidone (example: poly(ethylene glycol graft vinyl acetate). The polyglycol proportion should be 5 to 100 wt. %, the graft proportion should be 0 to 95 wt. %; the latter can consist of one or more monomers. A graft proportion of 5 to 70 wt. % is particularly preferred; in this case, the solubility in water decreases with the graft proportion;
polyvinylpyrrolidone (PVP) with a molecular weight of 2,500 to 750,000 g/mol;
polyacrylamide with a molecular weight of 5,000 to 5,000,000 g/mol;
polyethyloxazoline and polymethyloxazoline with a molecular weight of 5,000 to 100,000 g/mol;
polystyrene sulfonates and their copolymers having comonomers such as ethyl (meth)acrylate, methyl (meth)acrylate, hydroxyethyl (meth)acrylate, ethylhexyl (meth)acrylate, butyl (meth)acrylate and the salts of (meth)acrylic acid such as sodium (meth)acrylate, acrylamide, styrene, vinyl acetate, maleic anhydride, vinyl pyrrolidone; the comonomer content should be from 0 to 80 mol % and the molecular weight should be in the range from 5,000 to 500,000 g/mol;
polyurethanes, in particular the reaction products of diisocyanates (e.g., TMXDI) with polyalkylene glycols, in particular polyethylene glycols with a molecular weight of 200 to 35,000, or with other difunctional alcohols to products with molecular weights of 2,000 to 100,000 g/mol;
polyesters with molecular weights of 4,000 to 100,000 g/mol, based on dicarboxylic acids (e.g., terephthalic acid, isophthalic acid, phthalic acid, sulfoisophthalic acid, oxalic acid, succinic acid, sulfosuccinic acid, glutaric acid, adipic acid, sebacic acid, etc.) and diols (e.g., polyethylene glycols, for example with molecular weights from 200 to 35,000 g/mol);
particularly preferably a polyester which comprises at least one repeating unit from sulfoisophthalic acid as a monomer;
cellulose ethers/esters, e.g., cellulose acetates, cellulose butyrates, methyl cellulose, hydroxypropyl cellulose, hydroxyethyl cellulose, methylhydroxypropyl cellulose; methyl hydroxyethyl cellulose;
polyvinyl methyl ether with molecular weights from 5,000 to 500,000 g/mol,
polyamide polymer, which preferably has molecular weights in the range from 5,000 to 30,000 g/mol (for example Crystasense® HP 4 ex Croda); the polyamide polymer particularly preferably contains polyalkylene oxide units; at least one polyamide polymer is preferably selected from polyamide polymer according to WO 2013/012476 A2, WO 2010/033595 A1, WO 02/059181 A2, WO 2004/083280 A1 or mixtures thereof.

The polymer is preferably a structuring polymer, for example polyvinyl alcohol (also referred to as PVOH), PEG, or gelatin. A structuring polymer is particularly suitable for forming a network. In particular, it has one, two, or more, particularly one or two, preferably one polymer that is suitable for forming a network. In addition, the shell material of the shell and the melt thereof can have one or more polymers that do not form a network, but lead to a thickening and thus an increase in the dimensional stability of the shell, so-called thickening polymers.

According to the invention, the shell material and the melt thereof comprise the polymer suitable for forming networks in a proportion of about 5 wt. % to 40 wt. %, in particular from 7 wt. % to 35 wt. %, preferably 10 wt. % to 20 wt. %, based in each case on the total weight of the shell material. Due to significantly lower proportions of polymer, in particular gelatin and/or PVOH, the formation of a stable shell is only carried out with difficulty.

The shell material preferably comprises at least PVOH (polyvinyl alcohol) and/or at least gelatin as the polymer. PVOH and gelatin are suitable for forming networks and are therefore structuring polymers. Derivatives of PVOH are also suitable.

Polyvinyl alcohols are thermoplastic polymers that are produced as white to yellowish powders, usually by hydrolysis of polyvinyl acetate. Polyvinyl alcohol (PVOH) is resistant to almost all water-free organic solvents. Polyvinyl alcohols having a molar mass of from 30,000 to 60,000 g/mol are preferably contained in the shell material.

Within the meaning of the invention, derivatives of PVOH are preferably copolymers of polyvinyl alcohol with other monomers, in particular copolymers with anionic monomers. Suitable anionic monomers are preferably vinyl acetic acid, alkyl acrylates, maleic acid and derivatives thereof, in particular monoalkyl maleates (in particular monomethyl maleate), dialkyl maleates (in particular dimethyl maleate), maleic anhydride, fumaric acid and derivatives thereof, in particular monoalkyl fumarate (in particular monomethyl fumarate), dialkyl fumarate (in particular dimethyl fumarate), fumaric anhydride, itaconic acid and derivatives thereof, in particular monomethyl itaconate, dialkyl itaconate, dimethyl itaconate, itaconic anhydride, citraconic acid (methylmaleic acid) and derivatives thereof, monoalkyl citraconic acid (in particular methyl citraconate), dialkyl citraconic acid (dimethyl citraconate), citraconic anhydride, mesaconic acid (methyl fumaric acid) and derivatives thereof, monoalkyl mesaconate, dialkyl mesaconate, mesaconic anhydride, glutaconic acid and derivatives thereof, monoalkyl glutaconate, dialkyl glutaconate, glutaconic anhydride, vinylsulfonic acid, alkyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sulfoethyl acrylate and combinations thereof, and the alkali metal salts or esters of the above-mentioned monomers.

Particular preferred derivatives of PVOH are those selected from copolymers of polyvinyl alcohol with a monomer, in particular selected from the group of monoalkyl maleates (in particular monomethyl maleate), dialkyl maleates (in particular dimethyl maleate), maleic anhydride, and combinations thereof, and the alkali metal salts or esters of the above-mentioned monomers. The values stated for polyvinyl alcohols themselves apply to the suitable molecular masses.

In the scope of the present invention, it is preferable for the shell material to comprise a polyvinyl alcohol of which the degree of hydrolysis is preferably from 70 to 100 mol. %, in particular from 80 to 90 mol. %, particularly preferably from 81 to 89 mol. %, and in particular from 82 to 88 mol. %. Preferred polyvinyl alcohols are those present as white-yellowish powders or granular material having degrees of polymerization in the range of from approximately 100 to 2,500 (molar masses of from approximately 4,000 to 100,000 g/mol) and degrees of hydrolysis of from 80 to 99 mol. %, preferably from 80 to 90 mol. %, in particular from 87 to 89 mol. %, for example 88 mol. %, which accordingly also contain a residual content of acetyl groups.

PVOH powders which have the above-mentioned properties and are suitable for use in the shell material are marketed by Kuraray, for example, under the name Mowiol® or Poval®. Particularly suitable are the Poval® grades, in particular grades 3-83, 3-88 and preferably 4-88, and Mowiol® 4-88 from Kuraray.

The water solubility of polyvinyl alcohol can be altered by post-treatment with aldehydes (acetalization) or ketones (ketalization). Particularly preferred and, due to their decidedly good solubility in cold water, particularly advantageous polyvinyl alcohols have been produced which can be acetalized or ketalized with the aldehyde or keto groups of saccharides or polysaccharides or mixtures thereof. It is extremely advantageous to use the reaction products of polyvinyl alcohol and starch. Furthermore, the water solubility can be altered and thus set at desired values in a targeted manner using Ni or Cu salts or by treatment with dichromates, boric acid, or borax.

Gelatin is a mixture of substances composed of taste-neutral animal protein. The main component is denatured or hydrolyzed collagen, which is produced from the connective tissue of various animal species. Gelatin lacks the essential amino acid tryptophan, so it is not considered to be a complete protein. Gelatin swells in water and dissolves when heated from around 50° C. When it cools down, a gel forms which, when heated again, becomes liquid again.

Surprisingly, it has been found that, with the aid of gelatin, dimensionally stable shells can be produced within a short curing time. Furthermore, the shape and size of shells produced in this way remain stable over a long period of time. No size-shrinkage is observed. Pig or bovine gelatin is preferably used as the gelatin. It has been found that the quantity of gelatin necessary varies depending on the bloom value. Preferably, the shell material therefore has gelatin having a bloom value in the range of from 60 to 225. The bloom value describes the gel strength or gelling quality of gelatin. The characteristic number is the mass in grams that is required in order for a male mold measuring 0.5 inches in diameter to deform the surface of a 6.67% gelatin/water mixture four millimeters deep without breaking it. The experiment is conducted in a standardized manner at exactly 10° C. with preceding aging of the gelatin for 17 hours.

If the shell material comprises gelatin having a bloom value of 150 or more, in particular from 180 to 225, preferably from 200 to 225, the proportion of gelatin with respect to the total weight of the shell material is preferably in the range of from 10 wt. % to 20 wt. %, in particular of from 15 wt. % to 18 wt. %. If the bloom value is less than 150, particularly from 60 to 120, preferably from 60 to 100, the proportion of gelatin with respect to the total weight of the shell material is preferably in the range of from 15 wt. % to 30 wt. %, in particular from 20 wt. % to 25 wt. %. Gelatin with a bloom value of 180 or more, in particular 200 or more, particularly 225, is preferred. By using gelatin that has an appropriate bloom value, the viscosity of the melt of the shell material can be monitored effectively during production. Additionally, the quantity of gelatin required in this case is less than when gelatins having a lower bloom value are used, which can result in a reduction in costs.

Surprisingly, it has been found that PVOH and/or gelatin is particularly well suited to producing shell material that meets the specifications outlined above. Shell material which comprises gelatin and/or PVOH is therefore particularly preferred. If the shell material also comprises PVOH in addition to gelatin, the toughness of the shell material is increased during production.

As a preferred polymer, in particular as a structuring polymer, the shell material preferably contains at least one polyalkylene glycol, in particular polyethylene glycol.

Polyethylene glycols having an average molecular weight between 800 and 8000 g/mol are particularly suitable. The above-mentioned polyethylene glycols are particularly preferably used in quantities of from 1 to 40 wt. %, preferably from 5 to 35 wt. %, in particular from 10 to 30 wt. %, for example from 15 to 25 wt. %, in each case based on the total weight of the shell material.

A particularly preferred embodiment relates to shell material or the melt thereof, which contains polyvinyl alcohol as a polymer in combination with polyethylene glycol. Polyethylene glycols having an average molecular weight of 800 and about 2000 g/mol are particularly preferably used in combination with polyvinyl alcohol.

According to a particularly preferred embodiment, the shell material and the melt thereof comprise PVOH (polyvinyl alcohol). This shell material produced in this way is particularly high-melting, dimensionally stable (even at 40° C.) and does not change in shape during storage, or changes only insignificantly. In particular, they are also less reactive with respect to a direct negative interaction with components of the filling substance. PVOH can in particular also produce low-water or water-free shell material without any difficulties. Using PVOH as the polymer for the shell material results in low-viscosity melts at 110-120° C. which can therefore be processed particularly easily; in particular the filling of the melt into the container of the apparatus can be carried out quickly and accurately without any adhesion or without being inaccurately metered. Due to the rapid solidification of the melts of the shell materials with PVOH, the shell can be processed particularly quickly. Furthermore, the good solubility of the shells produced is particularly favorable for the overall solubility of the portion pack as a washing or cleaning agent.

A particularly preferred embodiment relates to shell material or the melt thereof containing polyamide polymer in combination with polyethylene glycol. It is particularly preferred to use polyethylene glycols having an average molecular weight of 800 to about 10,000 g/mol in combination with polyamide polymer.

Polyamide polymers having an average molecular weight in the range from 5,000 to 30,000 g/mol (for example Crystasense® HP 4 ex Croda) are preferably suitable as polyamide polymers. The polyamide polymer particularly preferably contains polyalkylene oxide units. At least one polyamide polymer is particularly preferably selected from polyamide polymer according to WO 2013/012476 A2, WO 2010/033595 A1, WO 02/059181 A2, WO 2004/083280 A1 or mixtures thereof.

Surprisingly, it has been found that the addition of non-polymeric polyethylene glycols, i.e., those with average molar masses below 800 g/mol, to the shell material, in particular in the case of shell material comprising polyvinyl alcohol as the polymer and for shell material comprising polyethylene glycol as the polymer, the solidification time of the melts of the shell material is accelerated. This is highly advantageous, in particular for the production sequences, since the further processing of the shells made of said shell material in the solidified state can take place much more quickly and therefore usually more cost-effectively. In particular, it is therefore advantageous if, in addition to polyvinyl alcohol, the shell material also comprises non-polymeric polyethylene glycols with a molecular weight of between 200 and 800 g/mol, particularly preferably between 300 and 800 g/mol, for example around 400 g/mol INCI: PEG400).

Most preferably, the shell material contains non-polymeric polyethylene glycol with a molar mass between 300 and 800 g/mol in amounts of 10 to 30 wt. % based on the total weight of the shell material.

In addition to the at least one polymer, the shell material and the melt thereof particularly preferably additionally comprise at least one polyhydric alcohol. The at least one polyvalent alcohol allows the production of a dimensionally stable, non-flowable shell within a short solidification time which within 15 minutes or less, particularly 10 minutes or less. Polyhydric alcohols within the meaning of the present invention are hydrocarbons in which two, three, or more hydrogen atoms are replaced by OH groups. The OH groups are each bonded to different carbon atoms. One carbon atom has not two OH groups. This is in contrast with (simple) alcohols, in which only one hydrogen atom is replaced by an OH group in hydrocarbons. Polyhydric alcohols having two OH groups are referred to as alkanediols, and polyhydric alcohols having three OH groups are referred to as alkanetriols. A polyhydric alcohol thus corresponds to the general formula [KW](OH)_{X}, where KW represents a hydrocarbon that is linear or branched, saturated or unsaturated, substituted, or unsubstituted. A substitution can occur with —SH or —NH groups, for example. Preferably, KW is a linear or branched, saturated or unsaturated, unsubstituted hydrocarbon. KW comprises at least two carbon atoms. The polyhydric alcohol comprises 2, 3, or more OH groups (x=2, 3, 4 . . . ), with only one OH group being bonded to each C atom of the KW. Particularly preferably, KW comprises 2 to 10, i.e. 2, 3, 4, 5, 6, 7, 8, 9, or 10, carbon atoms. Polyhydric alcohols in which x=2, 3, or 4 can be used in particular (for example, pentaerythritol where x=4). Preferably, x=2 (alkanediol) and/or x=3 (alkanetriol).

Particularly preferably, the shell material comprises at least one alkanetriol and/or at least one alkanediol, in particular at least one C₃ to C₁₀ alkanetriol and/or at least one C₃ to C₁₀ alkanediol, preferably at least one C₃ to C₈ alkanetriol and/or at least one C₃ to C₈ alkanediol, particularly at least one C₃ to C₆ alkanetriol and/or at least one C₃ to C₅ alkanediol, as a polyhydric alcohol. Preferably, it comprises one alkanetriol and one alkanediol as at least one polyhydric alcohol. In a preferred embodiment, the shell material thus comprises at least one polymer, in particular gelatin and/or PVOH and/or polyethylene glycol, as well as at least one alkanediol and at least one alkanetriol, in particular one alkanetriol and one alkanediol. A shell material comprising at least one polymer, in particular gelatin and/or PVOH and/or polyethylene glycol, and a C₃ to C₈ alkanediol and a C₃ to C₈ alkanetriol, is also preferred. Furthermore, shell material is preferred comprising at least one polymer, particularly gelatin, and/or PVOH, and/or polyethylene glycol, and a C₃ to C₅ alkanediol, and a C₃ to C₆ alkanetriol.

Surprisingly, it has been found that, when a corresponding triol (alkanetriol) is combined with a corresponding diol (alkanediol), particularly short solidification times of the melt of the shell material can be achieved. The shells obtained are also transparent and have a glossy surface, which ensures an appealing visual impression of the shells according to the invention and the portion packs contained therein. The terms “diol” and “alkanediol” are used synonymously herein. The same applies to “triol” and “alkanetriol.”

According to the invention, the polyhydric alcohols do not comprise any derivatives thereof, such as ethers, esters, etc.

The quantity of polyhydric alcohol or polyhydric alcohols used in shell material according to the invention is preferably at least 45 wt. %, in particular 55 wt. % or more. Preferred amount ranges are from 5 wt. % to 75 wt. %, in particular from 10 wt. % to 70 wt. %, based on the total weight of the shell material.

Preferably, the C₃ to C₆ alkanetriol is glycerin and/or 2-ethyl-2-(hydroxymethyl)-1,3-propanediol (also called 1,1,1-trimethylolpropane or EHPD) and/or 2-amino-2-(hydroxymethyl)-1,3-propanediol (TRIS, tris hydroxymethyl aminoethane).

The C₃ to C₆ alkanetriol is particularly preferably glycerol and/or 2-ethyl-2-(hydroxymethyl)-1,3-propanediol (also called 1,1,1-trimethylolpropane). The C₃ to C₅ alkanediol is preferably 1,3-propanediol and/or 1,2-propanediol. Surprisingly, it has been found that the chain length of the diol as well as, in particular, the position of the OH groups has an influence on the transparency of the shell. The OH groups of the diol are therefore preferably not arranged on immediately adjacent C atoms. In particular, three or four carbon atoms, in particular three carbon atoms, are located between the two OH groups of the diol. Particularly preferably, the diol is 1,3-propanediol. Surprisingly, it has been found that particularly good results are obtained with mixtures that comprise glycerol and 1,3-propanediol and/or 1,2-propanediol.

Particularly preferably, the shell material comprises gelatin, glycerin, and 1,3-propanediol or gelatin, 1,1,1-trimethylolpropane and 1,3-propanediol. Here, a non-flowable consistency that is dimensionally stable at room temperature can be achieved within a solidification time of 10 minutes or less that remains dimensionally stable even after an extended storage period. In addition, such a shell is transparent and has a glossy surface. A particularly preferred shell and a particularly preferred shell material therefore comprises gelatin or PVOH as a polymer and 1,3-propanediol and glycerol or 1,1,1-trimethylolpropane as polyhydric alcohols.

If the shell material comprises an alkanetriol, in particular glycerin or 1,1,1-trimethylolpropane, then the proportion of alkanetriol, in particular glycerin or 1,1,1-trimethylolpropane, is between 3 and 75 wt. %, preferably 5 wt. % to 70 wt. %, in particular 10 wt. % to 65 wt. %, particularly 20 wt. % to 40 wt. %, based on the total weight of the shell material.

If the shell material optionally comprises a plurality of alkanetriol(s), then the total proportion of alkanetriol(s) is between 3 and 75 wt. %, preferably 5 wt. % to 70 wt. %, in particular 10 wt. % to 65 wt. %, particularly 20 wt. % to 40 wt. %, based on the total weight of the shell material.

If glycerol is contained as an alkanetriol in the shell material, then the proportion of glycerol based on the total weight of the shell material is preferably 5 wt. % to 70 wt. %, in particular 10 wt. % to 65 wt. %, particularly 20 wt. % to 40 wt. %.

If 1,1,1-trimethylolpropane is contained in the shell material, then the proportion of 1,1,1-trimethylolpropane based on the total weight of the shell material is preferably 5 wt. % to 70 wt. %, in particular 10 wt. % to 65 wt. %, particularly preferably 18 to 45 wt. %, in particular preferably 20 wt. % to 40 wt. %.

If 2-amino-2-hydroxymethyl-1,3-propanediol is contained in the shell material, then the proportion of 2-amino-2-hydroxymethyl-1,3-propanediol based on the total weight of the shell material is preferably 5 wt. % to 70 wt. %, in particular 10 wt. % to 65 wt. %, particularly 20 wt. % to 40 wt. %.

If a plurality of alkanediols are optionally contained in the shell material, the proportion of alkanediols, based on the total weight of the shell material, is preferably 5 wt. % to 70 wt. %, in particular 7 wt. % to 65 wt. %, particularly 10 wt. % to 40 wt. %.

If the shell material comprises at least one alkanediol, in particular 1,3-propanediol or 1,2-propanediol, then the proportion of alkanediol, in particular 1,3-propanediol or 1,2-propanediol, based on the total weight of the shell material, is preferably 5 wt. % to 70 wt. %, in particular 10 wt. % to 65 wt. %, particularly 20 wt. % to 45 wt. %. If 1,3-propanediol is contained in the shell material, the proportion of 1,3-propanediol, based on the total weight of the shell material, is in particular 10 wt. % to 65 wt. %, particularly 20 wt. % to 45 wt. %.

Preferably, a shell material containing 20 to 45 wt. % of 1,3 propanediol and/or 1,2 propanediol and 10 to 65 wt. % of 2-amino-2-hydroxymethyl-1,3-propanediol, in each case based on the total weight of the shell material, is used. Also preferred is a shell material containing 20 to 45 wt. % of 1,3 propanediol and/or 1,2 propanediol and 10 to 65 wt. % of 1,1,1-trimethylolpropane, in each case based on the total weight of the shell material. In particular, a shell material containing 20 to 45 wt. % of 1,3 propanediol and/or 1,2 propanediol and 10 to 65 wt. % of glycerol, in each case based on the total weight of the shell material, is preferred.

It has been found that, in these ranges, quick solidification of a shell material is possible at 20° C.; the shells obtained are stable in storage and transparent. In particular, the glycerol proportion has an impact on the curing time.

If the shell material according to the invention comprises a C₃ to C₆ alkanetriol and a C₃ to C₅ alkanediol, then the weight ratio thereof is preferably 3:1 to 2:1. In particular, the weight ratio is 2:1 if glycerin and 1,3-propanediol are contained as polyhydric alcohols. Surprisingly, it has been found that, with these weight ratios, storage-stable, glossy, transparent shells can be obtained within short solidification times of 10 minutes or less at 20° C.

According to a further preferred embodiment, in addition to the above-mentioned alkanols, triethylene glycol may be present in the shell material, in particular the shell material described above as being preferred, in particular if this shell material contains PVOH as a polymer. Triethylene glycol advantageously accelerates the solidification of the melts of the shell material. It is particularly preferred if the shell material, in addition to 1,3- and/or 1,2-propanediol and glycerin, contains, based on its weight, between 0.1 and 20 wt. %, preferably between 1 and 15 wt. %, in particular between 5 and 12 wt. %, for example 8 to 11 wt. %, triethylene glycol.

The following compositions are, for example, conceivable as a formulation for a shell material according to the invention, designated as E1 to E7 in percent by weight:

| | E1 | E2 | E3 | E4 | E5 |
|---|---|---|---|---|---|
| | [wt. %] | [wt. %] | [wt. %] | [wt. %] | [wt. %] |
| Acusol 588 G ¹ | 8 | 8 | 8 | 8 | 8 |
| PEG 400 | 0 | 6 | 8 | 8 | 6 |
| Glycerin | 40 | 40 | 40 | 30 | 40 |
| 1,3-propanediol | 26 | 22 | 20 | 30 | 22 |
| Polyvinyl alcohol ² | 20 | 18 | 18 | 18 | 18 |
| Citric acid anhydrate | 6 | 6 | 6 | 6 | 6 |
| total | 100 | 100 | 100 | 100 | 100 |

| | E6 [wt. %] | E7 [wt. %] |
|---|---|---|
| DL-Alanine | 15.0 | 15.0 |
| N,N-diacetic acid | | |
| trisodium salt | | |
| (MGDA) | | |
| (powder <100 μm) | | |
| Genapol EC 50 ⁴ | 7.0 | 7.0 |
| Acusol 588 G | 8.0 | 8.0 |
| (powder <100 μm) | | |
| Crystasense HP4 ⁵ | 13.0 | 13.0 |
| HEDP ⁶ | 7.0 | 7.0 |
| (powder <100 μm) | | |
| PEG 300 | 15.0 | 15.0 |
| PEG 6000 | 22.0 | 22.0 |
| Citric acid anhydrate | 4.0 | 3.8 |
| (powder <100 μm) | | |
| Soda | 5.0 | 5.0 |
| (powder <100 μm) | | |
| Dye (blue) | — | 0.2 |
| total | 100 | 100 |

¹ Copolymer of acrylic acid having a monomer containing sulfonic groups (DOW)
² Partially hydrolyzed polyvinyl alcohol with a degree of polymerization (DP) of 900 and a degree of hydrolysis of 87.5 mol % (Kuraray)
³ Available as Trilon M ® (BASF SE)
⁴ Nonionic surfactant: waxy alkyl ether with ethylene oxide and propylene oxide units (Clariant)
⁵ Polyamide polymer with an average molecular weight of 9500 g/mol (ex Croda)
⁶ Etidronic acid tetrasodium salt (Zschimmer & Schwarz)

Another improvement of the invention provides that the shell material additionally contains at least one active ingredient. As a result, an appropriately produced shell can also act as a washing or cleaning agent in addition to its function as a container.

The active ingredient is preferably selected from soil-release active ingredient, enzyme, builders, complexing agents, optical brighteners (preferably in portion packs for textile washing), pH adjusters, perfume, dyes, dye transfer inhibitors or the mixtures thereof. Further preferred representatives of these active ingredients are the embodiments of these active ingredients explained in more detail below in connection with the filling substance (vide infra).

A bitter substance, such as denatonium benzoate, can preferably also be contained in the melt. It can thus be prevented that a shell produced by means of the apparatus or a portion pack according to the invention containing this shell is swallowed, for example, by children or pets. It is therefore preferred according to the invention if the shell material according to the invention contains at least one bittering agent.

Preferred bittering agents have a bitter value of at least 1,000, preferably at least 10,000, particularly preferably at least 200,000. In order to determine the bitter value, the European Pharmacopoeia (5th Edition, Grundwerk, Stuttgart 2005, Volume 1, General Part, Monograph Groups, 2.8.15 bitter value p. 278) uses the standardized processes described. An aqueous solution of quinine hydrochloride, of which the bitter value is fixed at 200,000, is used as a comparison. This means that 1 gram of quinine hydrochloride makes 200 liters of water bitter. The inter-individual taste differences in the organoleptic examination of bitterness are compensated for by a correction factor in the process.

Very particularly preferred bittering agents are selected from denatonium benzoate, glycosides, isoprenoids, alkaloids, amino acids, and mixtures thereof, particularly preferably denatonium benzoate.

Glycosides are organic compounds of the general structure R—O—Z, in which an alcohol (R—OH) is linked to a sugar part (Z) by means of a glycosidic bond.

Suitable glycosides are, for example, flavonoids such as quercetin or naringin or iridoidglycoside such as aucubin and in particular secoiridoid glycosides, such as amarogentin, dihydrofoliamentin, gentiopicroside, gentiopikrin, swertiamarin, sweroside, gentioflavoside, centauroside, methiafolin, harpagoside and centapikrin, sailicin or condurangin.

Isoprenoids are compounds that are formally derived from isoprene. Examples are in particular terpenes and terpenoids.

Suitable isoprenoids comprise, for example, sequiterpene lactones such as absinthin, artabsin, cnicin, lactucin, lactucopikrin or salonitenolide, monoterpene ketones (thujones) such as α-thujon or ß-thujone, tetranortriterpenes (limonoids) such as deoxylimones, desoxylimonic acid, limonin, ichangin, iso-obacunonic acid, obacunone, obacunonic acid, nomilin or nomilic acid, terpenes such as marrubin, premarrubin, carnosol, carnosolic acid or quassin.

Alkaloids refer to naturally occurring, chemically heterogeneous, mostly alkaline, nitrogen-containing organic compounds of secondary metabolism that act on the animal or human organism.

Suitable alkaloids are, for example, quinine hydrochloride, quinine hydrogen sulfate, quinine dihydrochloride, quinine sulfate, columbine and caffeine.

Suitable amino acids comprise, for example, threonine, methionine, phenylalanine, tryptophan, arginine, histidine, valine and aspartic acid.

Particularly preferred bitterns are quinine sulfate (bitter value=10,000), naringin (bitter value=10,000), sucrose octaacetate (bitter value=100,000), quinine hydrochloride, denatonium benzoate (bitter value >100,000,000) and mixtures thereof, very particularly preferably denatonium benzoate (for example available as Bitrex®).

Based on its total weight, the shell material preferably contains bittering agents in a total amount of at most 1 part by weight of bitter substance to 250 parts by weight of shell material (1:250), particularly preferably at most 1:500, very particularly preferably at most 1:1,000.

Furthermore, granular material or particles or solids are preferably contained in the melt.

The shell material is particularly preferably elastic (preferably under standard condition). The elasticity of the shell material is determined in the sense of the invention by creating a force/displacement diagram. The melt of the shell material is poured into a molded body measuring 47×19×8 mm and stored at room temperature for 12 hours before the measurement. The sample was taken in modified plastic inserts having external dimensions of 25×20×20 mm and having a recess of 10×10×20 mm for the mass to be measured. The measurement instrument used is a Lloyd LRX+ (Lloyd Instruments) having a 5 kN measuring head, with a feed rate of 50 mm/min and a measurement pickup at 1 N preload (zero point) having been set. As a result, the force necessary to compress the molded body by 8 mm is given in N. Due to the elasticity of the shell material, the initial dimensions of the molded body are reset within a period of 15 minutes after the measurement has ended. The values measured in this way (for compression by 8 mm) are preferably between 10 N and 40 N, preferably between 15 N and 30 N.

A shell produced accordingly has advantageous mechanical properties and can in particular be transported, stored, and handled undamaged. In addition, when material is filled into the interior of a shell, it can thus yield and, for example in the case of a material configured as a solid body, adapt to its shape.

The shell can be printed with text or graphic motifs on the outer surface or the inner surface. The use of inkjet printing, airbrush technology, or pad printing is preferred. The print can be multicolored or black and white. For this purpose, the apparatus according to the invention can have a printing unit.

The male mold is preferably polished, for example polished to a high gloss.

The male mold can be realized, for example, via a mechanism with one degree of freedom, such as via a roller rotatable about a horizontal axis having one or more revolving rows of radially outward-pointing male molds, or via a vertically movable lifting platform having male molds pointing downward, i.e., in the direction of gravity. A mechanism having a plurality of degrees of freedom can also be provided so that the male mold is not only lowered into the melt and lifted out of it, but is then transported further as required, for example by a vertical movement for lowering and removal and by a further horizontal movement for further transport, for example to be detached or filled, or cured.

One of the advantages of this apparatus is that it has a simplified structure compared to known solutions, with base bodies in the form of male molds that can be easily produced and replaced. For example, the male molds do not have to have evacuation channels, as they are provided in deep drawing, since the shell material is formed by hydrostatic pressure within the melt instead of an artificially generated air pressure difference.

The male mold can preferably also have temperature regulators, which can preferably be arranged at least partially in the interior of the male mold, for heating or cooling the male mold.

Such a temperature regulator can be designed, for example, as a heating coil or as a Peltier element or as a liquid cooling system. In this way, the formation of the shell can be controlled, for example accelerated or slowed down in time, or the geometric thickness of the shell can be influenced, shells can also be easily detached from the male mold by heating the male mold and/or faulty shells can be destroyed and/or their material can be detached from the male mold. It is also conceivable that the male mold sits on a cooling block through which cooling brine flows. The solidification of the shell material can thereby be influenced, for example accelerated.

A preferred further development of the invention provides that the tank has a shape which substantially corresponds to an inversion of the shape of the male mold.

As a result, only small amounts of melt have to be made available and heated above the melting temperature thereof in order to sink the male mold into the melt, which reduces the production outlay in the production of the shell and in the operation of the apparatus. The geometry of the shell can also be influenced in this way. For example, a constant or variable distance from the male mold to the tank can have an amount of up to 1 cm, 1 mm, 100 μm, or 10 μm.

A shell that is in direct contact with the surface of the male mold is also referred to as a primary shell layer in the scope of this invention. A primary shell layer can already serve as such as a shell of a washing or cleaning agent portion pack according to the invention. However, further shell material in the form of a further melt can preferably be applied to the primary shell layer located on the male mold and converted into a further shell layer in contact with the primary shell layer before the shell is removed from the male mold. Therefore, for the apparatus according to the invention, at least one further tank having at least one further melt of a further shell material is particularly preferably provided, wherein the male mold having the shell already resting thereon is automatically lowerable into the further melt and withdrawable from the further melt in order to form a further water-soluble shell resting against the water-soluble shell resting on the male mold.

In this way, at least two, or even more than two, for example onion skin-like layers of shell or shell segments can be realized. These can, for example, increase the mechanical strength of the composite shell. In the case of two shells lying next to one another, the inner shell in each case has a lower melting point or a lower melting temperature than the outer shell.

It is particularly preferred that the multiple melts contain different active ingredients and/or different granular material.

Thus, for example, different cleaning cycles that are specifically staggered in time can be defined. For example, an outer shell can contain no active ingredient, a first inner shell can contain a pre-cleaning agent such as a pre-wash or a pre-washing agent and a second inner shell can contain a washing agent or detergent and an abrasive or active cleaning granular material. Any other combination can also be realized.

It is also preferred if the plurality of melts have different optical properties, in particular in the solidified state under standard conditions. These optical properties can relate, for example, to color, gloss, mattness, transparency, translucency, or to the refractive index.

In this way, information, for example about the intended purpose or the contents of the shell, or also a visually appealing impression can be conveyed to a user of the shell to be produced.

Preferred embodiments of the filling substance are the embodiments defined for the subject of the invention of the portion pack (vide infra).

An additional improvement of the invention is achieved in that one end of the male mold has a portion comprising a viscoelastic, solid filling substance.

This filling substance arranged at the end of the male mold, which, like the rest of the male mold, defines the shape of the shell and thus acts as a male mold, preferably has a melting or sol-gel temperature under standard conditions, which is above the temperature of the melt of the shell material. As a result, this filling substance does not melt when it is lowered into the melt. Thus, when the shell is detached, a filling substance arranged in the shell and connected to it can be detached from the rest of the male mold, for example broken off or repelled or split off or separated. The above-mentioned filling substance preferably has an active ingredient.

In a special development of the invention, the male mold is designed in such a way that a rigid shell lying on it cannot be stripped off.

This can prevent the shell from being accidentally detached from the male mold, for example as a result of gravity. Only, for example, by deforming a deformable or elastic shell or, for example, by destroying a rigid shell, i.e., for example, with the application of force in addition to gravity, can a corresponding shell be detached from such a male mold.

The male mold is preferably wider in a distal region than in a proximal region, the distal region pointing in the direction of one end of the male mold and the proximal region pointing toward an opposite end, wherein a shell resting on the male mold is closed in the distal region and is open in the proximal part. The transition from the distal to the proximal part can preferably be continuous, i.e., without jumps or steps. For example, a male mold aligned in the direction of gravity can taper upward so that it is, for example, at least partially conical.

The male mold can likewise preferably have a lateral unevenness, preferably have a protruding projection or an indentation pointing inward.

Such an unevenness creates an undercut that can fix the shell on the male mold. The shell can nevertheless be detached by applying additional force, by means of which the shell is, for example, elastically or inelastically deformed or destroyed in places. In the absence of additional expenditure of force, the undercut prevents unintentional detachment or stripping or falling off of the shell, for example if it expands to a small extent relative to the unevenness or if the male mold contracts to such a small extent, or in particular in the event of vibrations.

The male mold can also advantageously be set in vibration. Such a vibration can be triggered by mechanical actuators or piezo elements and, depending on the intended function, have frequencies in the range of more than 0.1 Hz, 1 Hz, 10 Hz, 100 Hz, 1 kHz, or 10 kHz. During immersion, for example, this can be used to level the melt pool by means of preferably lower frequencies, for example below 10 Hz. Likewise, by means of preferably higher frequencies, for example above 1 Hz, the detachment of the shell can be facilitated.

Likewise preferably, at least one air duct which can be connected to a compressed air source is provided in the interior of the male mold and opens onto the surface of the male mold. By applying compressed air to the at least one air duct, the shell can thus be detached by blowing it off.

A process according to the present invention provides that, for production of a water-soluble shell for holding a (preferably viscoelastic, solid) filling substance, an apparatus as described above is provided, the male mold is lowered into the melt at a temperature below a melting temperature of the melt, so that a contact surface of the male mold is covered with shell material, a shell is formed by the solidification of a layer of the shell material on the male mold, and the male mold having a shell adhering thereto is lifted from the melt before, after, or during the solidification, and the shell is detached from the male mold. The shell can then be placed on a conveyor belt, for example, in order to be further processed.

For example, the melt can be heated from 80° C. to 150° C., for example to 120° C. Likewise, for example, the male mold can be cooled from −20° C. to 0° C., for example −10° C.

The male mold is particularly preferably lowered into the melt to a depth which is greater than a maximum width of the male mold.

In this way, an elongated shell can be provided, which in classic deep-drawing process would lead to considerable mechanical stresses and potential damage during or after production.

Particularly preferably, the shell is detached by rolling it out or turning it inside out.

This means that the shell is not detached, or not only by stripping or pulling off or sliding off the male mold, but at least partially because an inside of the shell resting on the male mold, preferably at an open end of the shell, is turned from the inside out. In this way, for example, sticky shells can be removed that are difficult to remove, and shells can be removed from male molds that have unevenness, for example protrusions, or indentations, or undercuts, or other geometries deviating from parallel side walls.

Alternatively, the shell is detached by blowing it off. For this purpose, at least one air duct which can be connected to a compressed air source and opens onto the surface of the male mold can be provided in the interior of the male mold. By applying compressed air to the at least one air duct, the shell is detached by blowing it off. If there is more than one duct, the air pressure can be output in a specific, non-simultaneous sequence at different points on the surface of the male mold by means of a corresponding fluidic circuit, for example by means of time-shifted controlled valves. In this way, for example, in the case of a male mold having a proximal region in which the shell rests laterally circumferentially, and a distal region in which the shell finally rests at the end, compressed air can first be passed into the proximal region and only then into the distal region, whereby an adjacent shell is first lifted in the laterally circumferential region and only then pushed off from the end. This avoids excessive mechanical stress, in particular longitudinal tensile stress, on the shell.

A very preferred embodiment of the invention provides that one end of the male mold has a portion comprising (preferably viscoelastic, solid) filling substance and the portion is detached when the shell is detached, so that the shell having the filling substance arranged therein is detached.

A plurality of advantages is thereby achieved. For example, only one work step is required to provide a shell filled with filling substance. In addition, the direct contact of the liquid and curing shell material having the filling substance in the end of the male mold allows a particularly stable connection between the shell and the filling substance arranged therein. In particular, but not only if the filling substance is formed in the form of a solid, in particular a porous solid body, the melt can thus bond particularly well with the solid body, for example in that the laminar or gel-like, or liquid, or thin-bodied melt flows, diffuses, or seeps into microscopic bulges of a porous filling substance.

Another preferred embodiment of the invention is one in which the shell is detached under the action of sound waves, in particular ultrasonic waves.

Such detachment can be carried out particularly gently, avoiding stressing the shell with, in particular, inhomogeneous mechanical loads. It is conceivable, for example, to detach the shell locally periodically from the male mold under the influence of a sound wave and thus, for example, to slide it down from the male mold solely through the action of directed force due to gravity.

The shell is further preferably cured by hot air drying. Alternatively or additionally, a layer can preferably be vapor-deposited onto the shell.

As a result, regardless of the nature of the shell, a protective layer produced by hot air drying or added by vapor deposition can be created, which is more resistant to environmental influences or mechanical influences than a base body of the shell lying under the protective layer.

The shell can also be stabilized by cooling or curing.

Such a shell is particularly preferably further processed into a portion pack for use as a washing or cleaning agent by filling the shell according to the invention with at least one filling substance and optionally closing the shell.

This at least one filling substance of the portion pack is necessarily viscoelastic and solid. In addition, at least one other filling substance different therefrom can be present in the portion pack, which can, for example, be liquid, solid, or granular.

The opening of the shell defined by the male mold can be closed by sealing with a water-soluble film.

For example, the film can be glued, welded—for example by heat and/or ultrasound—or attached by means of a form fit. The use of solvents for attachment, i.e., sealing, is also conceivable.

It is particularly preferred to close the shell by wrapping it in a shrink film made of water-soluble film. As a result, not only is the entire shell also spatially away from at least one opening that necessarily remains after detachment from the male mold, sealed by the film, i.e., protected against external influences, but the mechanical stability is also increased.

The water-soluble film preferably contains at least one water-soluble polymer, particularly preferably selected from polymers or polymer mixtures.

It is preferable that the water-soluble film contains polyvinyl alcohol or a copolymer of polyvinyl alcohol.

A bittering agent is preferably incorporated into the above-mentioned water-soluble film to increase product safety. Corresponding embodiments of the water-soluble films having a bittering agent are described in publications EP-B1-2 885 220 and EP-B1-2 885 221. The bittering agents preferably used in the shell material are also preferably suitable for use in the water-soluble film. A particularly preferred bittering agent for the water-soluble film is denatonium benzoate.

Suitable water-soluble films are sold by MonoSol LLC under the name Monosol M8630 or M8720. Other suitable films include films having the designation Solublon® PT, Solublon® KA, Solublon® KC, or Solublon® KL from Aicello Chemical Europe GmbH, or the VF-HP films from Kuraray, or HiSelon SH2312 or S-2100 from Nippon Gohesi.

It is preferred according to the invention if the viscoelastic, solid filling substance in the shell is formed by curing a liquid composition. The viscoelastic, solid filling substance of the portion pack according to the invention can be produced in this manner by initially bringing a liquid composition, containing, based on the total weight thereof, a total amount of more than 0.5 wt. % of at least one previously defined gelator compound, in the presence of a solvent (optionally containing water) and 0.1 to 70 wt. % surfactant and, if necessary, optional additives, to a temperature above the sol-gel transition temperature of the liquid composition, and subsequently by introducing the heated liquid composition into the above-mentioned shell and cooling it in said mold to below the sol-gel transition temperature in order to form a viscoelastic, solid molded body.

It is also possible to initially bring a first liquid composition containing at least one above-mentioned gelator compound to a temperature above the sol-gel transition temperature of the first liquid composition and to mix and add this first liquid composition having a second liquid composition to the shell for curing at a temperature below sol-gel transition temperature of the first composition, containing water and at least one surfactant, to obtain a liquid composition containing at least 0.5 wt. % of at least one said gelator compound, 0.1 to 70 wt. % of at least one surfactant, and optionally water.

The respective liquid composition is brought to below the sol-gel transition temperature of the liquid composition in the mold for curing the liquid composition. In this case, it is preferable according to the invention for the liquid composition to be cooled to no lower than 30° C., in particular to no lower than 35° C., particularly preferably to no lower than 45° C., in order to form the above-mentioned filling substance.

Such a film, like all other components of each shell or portion pack described in this case, can contain a bittering agent such as denatonium benzoate.

Alternatively or additionally, the shell can be closed by applying a melt, in particular that melt by means of which the shell material was originally provided. When such a melt is applied, an already solidified part of the shell may liquefy again, especially in an edge region of an opening in the shell, so that a connection is created there, preferably in the form of a seamless material bond.

For example, after the shell has been detached and filled—for example by detachment or only afterward—it can be turned over and immersed with one open end facing down, i.e., in the direction of gravity, into the melt originally used for the shell. Alternatively, the melt can be applied to the opening from above or poured into it. However, another melt can also be provided for sealing.

Closing or sealing by means of a form fit connection, by mechanically connecting a cover, for example made of shell material, to the opening of the shell, for example using a screw closure or a latching mechanism, or an undercut, is also conceivable.

However, it is preferred according to the invention if the shell produced by means of the apparatus has an opening. The filling substance is visible and accessible through this opening. This increases, for example, the speed at which the portion pack according to the invention dissolves during use, since the water supplied in the washing or cleaning process can immediately come into direct contact with the filling substance.

### BRIEF DESCRIPTION OF THE DRAWINGS

FIG. 1 is a schematic representation of an embodiment of an apparatus according to the invention,

FIG. 2 is a schematic representation of a further embodiment of an apparatus according to the invention,

FIG. 3 is a schematic representation of a further embodiment of an apparatus according to the invention,

FIG. 4 is a schematic representation of an embodiment of a male mold according to the invention,

FIGS. 5a-5c are schematic representations of embodiments of shells and male molds according to the invention,

FIG. 6 is a schematic representation of an embodiment of a portion pack for use as a washing or cleaning agent according to the invention, and

FIG. 7 is a schematic representation of an embodiment of a process according to the invention.

### DETAILED DESCRIPTION OF THE INVENTION

FIG. 1 shows an apparatus 1 for production of a water-soluble shell 2 for holding a filling substance (not shown here). A melt 4 of a shell material 5 which contains a polymer is filled into a tank 3. This shell material 5 is elastic, solid, and water-soluble under standard conditions, i.e., in order to be present as melt 4, it is kept in tank 3 at a temperature above the melting temperature thereof. The shell material 5 also contains a cleaning active ingredient and denatonium benzoate.

In the region of the tank, a male mold 6a is movable in an initial state, namely vertically movable by means of an actuator (not shown here), the male mold 6a being automatically lowerable into the melt 4 and withdrawable from the melt 4.

In a subsequent step, a male mold 6b is lowered into the melt 4, i.e., arranged in such a way that at least a part of the male mold 6b is located below the surface of the melt.

The male mold 6a is submerged in the melt 4 over a length which is greater than the maximum width of the male mold 6b. Due, among other things, to the temperature difference between the melt 4 and male mold 6b as well as the stickiness and viscosity of the melt 4, as well as the specific heat capacity thereof, a layer of shell material 5 is formed in this state, which layer rests on the male mold 6b and adjoins it.

A male mold 6c is removed from the tank 3 and the melt 4 in a further subsequent step. A solid, gel-like, water-soluble shell 2 has formed therefrom by cooling the shell material 5 resting against the male mold 6c. The shell 2 does not have to be gel-shaped.

The male mold 6a; 6b; 6c has a temperature regulator (not shown in detail) on the inside, in order to accelerate the cooling and solidification of the shell 2, and to influence or predetermine the thickness of the shell 2.

In FIG. 2, an apparatus 1 is shown in which a tank 3a; 3b; 3c substantially has an inverted shape of a male mold 6a; 6b; 6c. In this example, this means that the male mold 6a; 6b; 6c is formed as an elongated dome and the tank 3a; 3b; 3c is formed as an elongated trough. As a result, the male mold 6a; 6b; 6c has—in this example—a constant, small distance from the tank 3a; 3b; 3c in the lowered state along the submerged part of the surface thereof.

In a first state, a tank 3a is only partially filled with a melt 4 of a shell material 5. In a second state, the male mold 6b is lowered into the tank 3b, as a result of which the melt 4 is displaced, so that its level rises and the male mold 6b is effectively lowered into the melt 4. In a third state, the male mold 6c is lifted out of the tank 3c, a shell 2 made of the shell material 5 adhering to the male mold 6c. The tank 3c is now empty, but a residual amount of melt 4 or shell material 5 can also remain there.

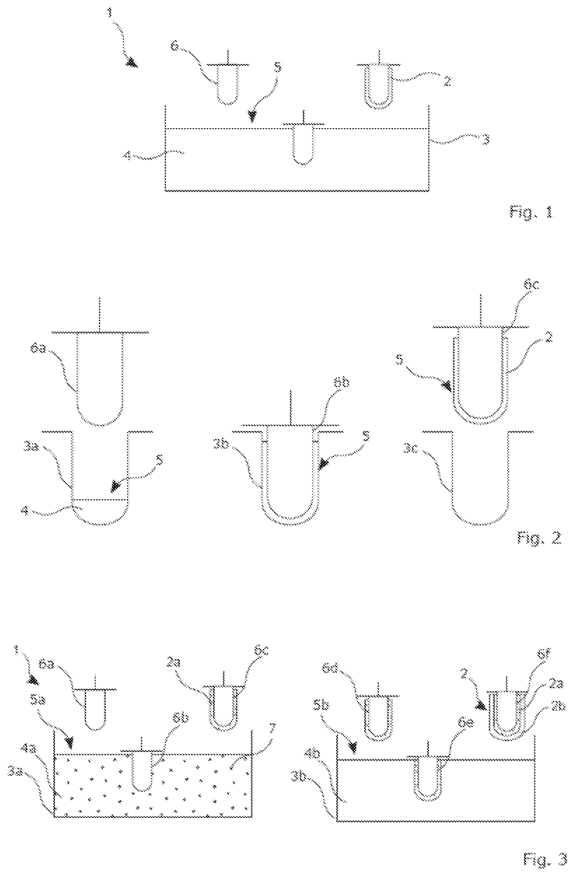

In FIG. 3, an apparatus 1 is shown having two spatially separated tanks 3a, 3b, wherein a first tank 3a is filled with a melt 4a having a granular material 7 contained therein, which contains an active ingredient, and wherein a second tank 3b having a melt 4b is filled, which contains no granular material. The male molds 6a-6f are in different states which are provided for the production of the shell 2.

In the region of the tank 3a, a male mold 6a is arranged above it in an initial state, the male mold 6a being automatically lowerable into the melt 4a and withdrawable from the melt 4a.

In a subsequent step, a male mold 6b is lowered into the melt 4a with the granular material 7 contained therein. Due, among other things, to the temperature difference between the melt 4a and the male mold 6b as well as the stickiness, viscosity, and specific heat capacity of the melt 4a and the amount, density, and specific heat capacity of the granular material 7, a layer of shell material 5a is formed in this state, which layer rests against the male mold 6b and adjoins it, in any case integrates with it.

A male mold 6c is removed from the tank 3a and the melt 4a in a further subsequent step. By cooling the shell material 5a resting on the male mold 6c, a solid, water-soluble shell 2a containing granular material 7 has formed therefrom.

Subsequently, as shown on male molds 6d and 6e, a male mold 6d having a first shell 2a adjoining is lowered into the second melt 4b of a second shell material 5b without granular material, so that a second shell 2b is formed which encloses the first shell 2a. In the final state, the male mold 6f is lifted out of the second melt 4b and the adjacent shells 2a, 2b are cooled so that they solidify and form a shell 2 composed of two layers.

The first shell 2a is opaque, while the second shell 2b is at least partially transparent, so that the first shell 2a and the granular material 7 contained therein are visible from the outside.

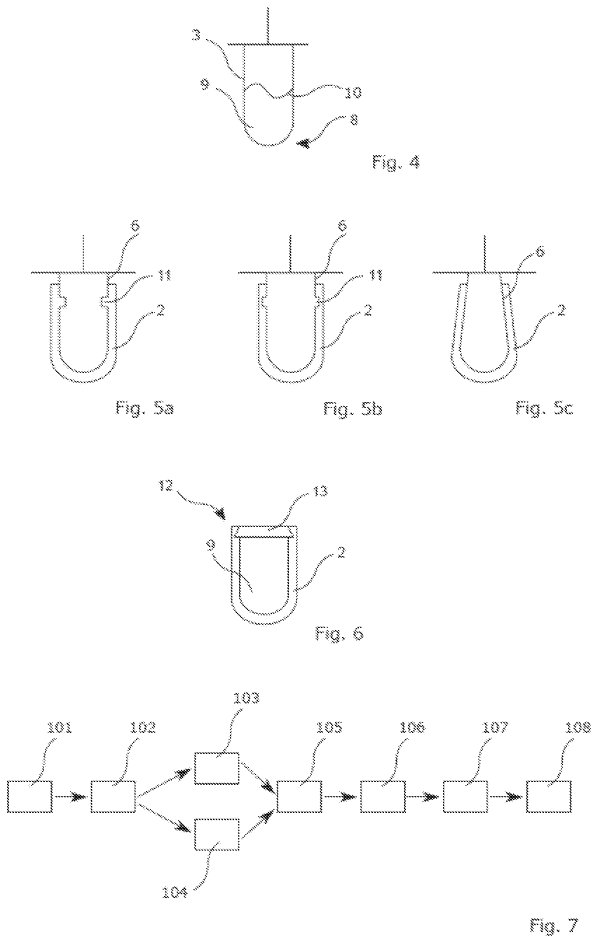

According to FIG. 4, one end 8 of the male mold 3 has a portion comprising filling substance 9. The separating surface 10 between the portion comprising the filling substance 9 and the rest of the male mold 6 is undulating, but can also be flat or have any shape. If such a male mold 6 is lowered into a melt 4 made of shell material 5 and removed therefrom, so that subsequently the shell material 5 solidifies to form a shell 2 resting on the filling substance 9, it is possible to separate, for example to break off or replace, this portion having the shell 2 resting on it from the rest of the male mold 6. In this way, a water-soluble shell 2 filled with a filling substance 9 is obtained in one work step.

FIGS. 5a, 5b and 5c show male molds 6 which are designed in such a way that rigid shells 2 lying thereon cannot be stripped off.

FIG. 5a shows a male mold 6 which has an unevenness 11 in the form of an indentation deviating from a cylindrical shape. FIG. 5b shows a male mold 6 which has an unevenness 11 in the form of a projection deviating from a cylindrical shape. The respective unevenness forms an undercut with regard to the shell 2 to be detached, so that this shell cannot be stripped off and cannot slip off. Only when the shell 2 (not shown here in more detail) is turned inside out, pulled apart, expanded radially, or destroyed in the region below the unevenness, can the shell be detached from the male mold.

FIG. 5c shows a male mold 6 which is wider in a distal region than in a proximal region, having the male mold 6 being partially conical. The conical shape forms an obstacle with regard to the shell 2 to be detached, so that this shell cannot be stripped off and cannot slip off. Only when the shell 2 (not shown here in more detail) is turned inside out, pulled apart, expanded radially or destroyed in places, can the shell be detached from the male mold.

FIG. 6 shows a portion pack for use as a washing or cleaning agent 12, having a shell 2, a filling substance 9 arranged therein and a cover 13 which is inserted into the shell 2 in a form-fitting manner. The cover consists of the shell material 5 of the shell 2, so it is in particular solid and water-soluble.

FIG. 7 shows the steps of a process for production of a water-soluble shell 2 for holding a filling substance 9 and for production of a corresponding portion pack for use as a washing or cleaning agent.

First, in a first step 101, an apparatus as described above for production of a water-soluble shell 2 is provided, comprising a tank 3 filled with a melt 5 of a shell material 4 and a male mold 6. Then, in a step 102, the male mold 6 is lowered into the melt 4 at a temperature below a melting temperature of the melt 4, so that a contact surface of the male mold 6 is covered with the shell material 5. This allows a shell 2 to be formed in a step 103 by solidification of the shell material 5 on the male mold 6. Before, after, or during the solidification in accordance with step 103, the male mold 6 is lifted out of the melt in a step 104, so that a shell 2 is provided on the male mold 6, which is detached from the male mold 6 in a step 105. In a step 106, the shell 2 is cured further by hot air drying and in a step 107 a protective layer (not shown here) is vapor-deposited onto the shell 2. The shell 2 is thus provided.

In a step 108, the shell 2 is filled with at least one filling substance 9. Subsequently, the shell 2 can optionally be closed in a step 109 by means of sealing with a water-soluble film, as a result of which a portion pack is provided for use as a washing or cleaning agent 12.

Another subject matter of the invention is a portion pack for use as a washing or cleaning agent, in particular as a textile washing agent or dishwashing agent, containing
(a) a shell made from a melt of a polymer-containing and water-soluble shell material that is solid under standard conditions, and
(b) a viscoelastic, solid filler substance contained in said shell, containing, based on the total weight of the above-mentioned filling substance,
   (i). a total amount of from 0.1 to 70 wt. % of at least one surfactant,
   and
   (ii). a total amount of at least 0.5 wt. % of at least one organic gelator compound with a molar mass <1000 g/mol, a solubility in water of less than 0.1 g/L (20° C.) and a structure containing at least a hydrocarbon structural unit with 6 to 20 carbon atoms (preferably at least one carbocyclic, aromatic structural unit) and additionally an organic structural unit covalently bonded to the aforementioned hydrocarbon unit, which has at least two groups selected from —OH, —NH—, or mixtures thereof
   and
   (iii). optionally water.

For this subject matter of the invention, it is preferred to use the embodiments of the shell material described above as preferred for the shell of the portion pack (vide supra).

It is also preferred if the shell of the portion pack is produced according to the process described above (vide supra).

It is preferred according to the invention if the viscoelastic, solid filling substance is incorporated firmly into the shell of the portion pack. This is preferably done in that the viscoelastic, solid filling substance is formed in the shell by curing a liquid composition.

It is preferred according to the invention if the shell of the portion pack has an opening. The viscoelastic, solid filling substance of the portion pack is visible and accessible through this opening. This increases, for example, the speed at which the portion pack according to the invention dissolves during use, since the water supplied in the washing or cleaning process can immediately come into direct contact with the filling sub stance.

The stability of the portion pack and the dissolving or dispersing power of the portion pack is further improved, when the above-mentioned filling substance has a storage modulus between 10³ Pa and 10⁸ Pa, (preferably between 10⁴ Pa and 10⁸ Pa, particularly preferably in a range from 10⁵ Pa to 10⁷ Pa) and a loss modulus (in each case at 20° C., with a deformation of 0.1% and a frequency of 1 Hz), and the storage modulus in the frequency range between 10⁻² Hz and 10 Hz is at least twice as great as the loss modulus, preferably five times greater than the loss modulus, particularly preferably at least ten times greater than the loss modulus.

The viscoelastic, solid filling substance according to the invention is preferably transparent or translucent. If a filling substance according to the invention has a residual light power (transmission) of at least 20% based on the reference measurement in the spectral range between 380 nm and 780 nm, it is considered transparent within the meaning of the invention.

The transparency of the viscoelastic, solid filling substance according to the invention can be determined using various methods. The Nephelometric Turbidity Unit (NTU) is frequently used as an indication of transparency. It is a unit, used e.g. in water treatment, for measuring turbidity e.g. in liquids. It is a unit of turbidity measured using a calibrated nephelometer. High NTU values are measured for clouded compositions, whereas low values are determined for clear, transparent compositions.

The HACH Turbidimeter 2100Q from Hach Company, Loveland, Colo. (USA), is used with the calibration substances StabICal Solution HACH (20 NTU), StabICal Solution HACH (100 NTU) and StabICal Solution HACH (800 NTU), all of which can also be produced by Hach Company. The measurement is filled with the composition to be analyzed in a 10 ml measuring cuvette having a cap and is carried out at 20° C.

At an NTU value (at 20° C.) of 60 or more, viscoelastic, solid filling substances have a perceptible turbidity within the meaning of the invention, as can be seen with the naked eye. It is therefore preferred if the viscoelastic, solid filling substance according to the invention has an NTU value (at 20° C.) of at most 120, more preferably at most 110, more preferably at most 100, particularly preferably at most 80.

In the scope of the present invention, the transparency of the viscoelastic, solid filling substances according to the invention was determined by a transmission measurement in the visual light spectrum over a wavelength range of from 380 nm to 780 nm at 20° C. To do this, a reference sample (water, deionized) is first measured in a photometer (Specord S 600 from AnalytikJena) with a cuvette (layer thickness 10 mm) that is transparent in the spectrum to be examined. The cuvette is then filled with a sample of the filling substance according to the invention and measured again. The sample is filled in the liquid state and solidified in the cuvette and then measured.

It is preferred if the viscoelastic, solid filling substance according to the invention has a transmission (20° C.) of particularly preferably at least 25%, more preferably at least 30%, more preferably at least 40%, in particular at least 50%, very particularly preferably at least 60%.

It is very particularly preferred if the viscoelastic, solid filling substance according to the invention has a transmission (at 20° C.) of at least 30% (in particular of at least 40%, more preferably of at least 50%, particularly preferably of at least 60%) and an NTU value (at 20° C.) of at most 120 (more preferably at most 110, more preferably at most 100, particularly preferably at most 80).

The shell of the portion pack and/or the viscoelastic, solid filling substance of the portion pack can be printed with text or graphic motifs.

The viscoelastic, solid filling substance according to the invention contains, based on the total weight thereof, a total amount of from 0.1 to 70 wt. % of surfactant. Suitable surfactants according to the invention are preferably anionic surfactants, nonionic surfactants, zwitterionic surfactants, amphoteric surfactants or cationic surfactants.

Preferred viscoelastic, solid filling substances contain, based on their total weight, a total amount of 5 to 70 wt. %, more preferably 5 to 65 wt. %, more preferably 5 to 60 wt. %, more preferably 10 to 70 wt. %, more preferably 10 to 65 wt %, more preferably 10 to 60 wt %, more preferably 15 to 70 wt %, more preferably 15 to 65 wt %, more preferably 15 to 60 wt %, particularly preferably 20 to 70 wt. %, more preferably 20 to 65 wt. %, more preferably 20 to 60 wt. %, very particularly preferably 25 to 70 wt. %, more preferably 25 to 65 wt. %, more preferably 25 to 60 wt. %, further preferably 30 to 70 wt. %, more preferably 30 to 65 wt. %, more preferably 30 to 60 wt. % of at least one surfactant. These surfactant compositions are particularly suitable for treating textiles, but in particular for use in a washing machine for textile washing. It is in turn particularly preferable for the viscoelastic, solid filling substance to contain at least one anionic surfactant and optionally also at least one nonionic surfactant.

Preferred embodiments of a viscoelastic, solid filling substance according to the invention for use as a dishwashing agent, in particular for use in a dishwasher, each contain, based on the weight of the composition, 0.1 to 5.0 wt. %, in particular 0.2 to 4.0 wt. %, of at least one surfactant.

A viscoelastic, solid filling substance that is preferred according to the invention is characterized in that it contains at least one anionic surfactant. Viscoelastic, solid filling substances according to the invention having anionic surfactant are particularly suitable for washing textiles, particularly preferably for use in a washing machine for washing textiles. Preferred viscoelastic, solid filling substances according to the invention, which are suitable as dishwashing agents (in particular for use in a dishwasher), each contain, based on the weight of the viscoelastic, solid filling substance according to the invention, 0 to 1 wt. %, in particular 0 to 0.5 wt. %, particularly preferably 0 to 0.25 wt. %, of anionic surfactant.

If the viscoelastic, solid filling substance according to the invention contains anionic surfactant and is used as a textile washing agent, it is preferred that, based on the total weight of the composition, anionic surfactant is contained in a total amount of 5 to 70 wt. %, more preferably 5 to 60 wt. %, more preferably 10 to 70 wt. %, in particular 10 to 60 wt. %, particularly preferably 10 to 40 wt. %, more preferably 25 to 40 wt. %.

Regardless of the field of application of the viscoelastic, solid filling substances according to the invention, sulfonates and/or sulfates can preferably be used as the anionic surfactant.

Surfactants of the sulfonate type that can be used are preferably C₉₋₁₃ alkylbenzene sulfonates, olefin sulfonates, i.e. mixtures of alkene and hydroxyalkane sulfonates, and disulfonates, as obtained, for example, from C₁₂₋₁₈ monoolefins having a terminal or an internal double bond by way of sulfonation with gaseous sulfur trioxide and subsequent alkaline or acid hydrolysis of the sulfonation products. C₁₂₋₁₈ alkane sulfonates and the esters of α-sulfofatty acids (ester sulfonates) are also suitable, for example the α-sulfonated methyl esters of hydrogenated coconut, palm kernel or tallow fatty acids.

Particularly preferred viscoelastic, solid filling substances according to the invention, in particular textile washing agents, contain at least one compound of the formula (T-1) as the anionic surfactant,

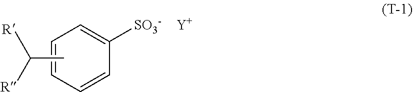

where
R′ and R″ are, independently of one another, H or alkyl, and together contain 9 to 19, preferably 9 to 15 and in particular 9 to 13, C atoms, and Y⁺ is a monovalent cation or the nth part of an n-valent cation (in particular Na⁺).

The alkali salts and in particular the sodium salts of the sulfuric acid half-esters of C₁₂-C₁₈ fatty alcohols, for example from coconut fatty alcohol, tallow fatty alcohol, lauryl alcohol, myristyl alcohol, cetyl alcohol or stearyl alcohol, or of C₁₀-C₂₀ oxo alcohols and the half-esters of secondary alcohols having these chain lengths are preferred as alk(en)yl sulfates. From a washing perspective, C₁₂-C₁₆ alkyl sulfates, C₁₂-C₁₅ alkyl sulfates and C₁₄-C₁₅ alkyl sulfates are preferred. 2,3-alkyl sulfates are also suitable anionic surfactants.

Fatty alcohol ether sulfates, such as the sulfuric acid monoesters of straight-chain or branched C₇₋₂₁ alcohols ethoxylated with 1 to 6 mol ethylene oxide, such as 2-methyl-branched C₉₋₁₁ alcohols having, on average, 3.5 mol ethylene oxide (EO) or C₁₂₋₁₈ fatty alcohols having 1 to 4 EO, are also suitable.

Other suitable anionic surfactants are soaps. Saturated and unsaturated fatty acid soaps are suitable, such as the salts of lauric acid, myristic acid, palmitic acid, stearic acid, (hydrogenated) erucic acid and behenic acid, and in particular soap mixtures derived from natural fatty acids, such as coconut, palm kernel, olive oil or tallow fatty acids.

The anionic surfactants, and the soaps, can be present in the form of sodium, potassium, magnesium or ammonium salts thereof. The anionic surfactants are preferably present in the form of the ammonium salts thereof. Preferred counterions for the anionic surfactants are the protonated forms of choline, triethylamine, monoethanolamine or methylethylamine.

In a very particularly preferred embodiment, the viscoelastic, solid filling substance according to the invention, in particular as a textile washing agent, contains an alkyl benzene sulfonic acid, in particular C₉₋₁₃ alkyl benzene sulfonic acid, neutralized with monoethanolamine, and/or fatty acid neutralized with monoethanolamine.

A preferred viscoelastic, solid filling substance according to the invention contains at least one anionic surfactant selected from the group consisting of C₈₋₁₈ alkylbenzene sulfonates, olefin sulfonates, C₁₂₋₁₈ alkane sulfonates, ester sulfonates, alkyl sulfates, alkenyl sulfates, fatty alcohol ether sulfates and mixtures thereof.

In the scope of a preferred embodiment, the viscoelastic, solid filling substance according to the invention, in particular as a washing or cleaning agent, contains at least one nonionic surfactant.

The at least one nonionic surfactant can be any known nonionic surfactant that is suitable for the purpose according to the invention.

In the scope of a preferred embodiment, the viscoelastic, solid filling substance contains at least one nonionic surfactant.

Preferred embodiments of a viscoelastic, solid filling substance according to the invention as a dishwashing agent, in particular for use in a dishwasher, each contain, based on the weight of the composition, 0.1 to 5.0 wt. %, in particular 0.2 to 4.0 wt. %, of at least one nonionic surfactant.

Preferred embodiments of a viscoelastic, solid filling substance according to the invention as a textile washing agent, in particular for use in a washing machine, each contain, based on the weight of the composition, 1.0 to 25 wt. %, preferably 2.5 to 20.0 wt. %, more preferably 5.0 to 18.0 wt. %, of at least one nonionic surfactant.

The at least one nonionic surfactant can be any known nonionic surfactant that is suitable for the purpose according to the invention.

In a preferred embodiment of the invention, the viscoelastic, solid filling substance described herein contain, as a nonionic surfactant, at least one fatty alcohol alkoxylate having the following formula (T-2),

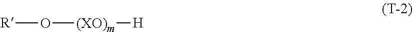

where R′ is a linear or branched C₈-C₁₈ alkyl functional group, an aryl functional group or alkylaryl functional group, XO is independently an ethylene oxide (EO) or propylene oxide (PO) group, and m is an integer from 1 to 50. In the above formula, R′ represents a linear or branched, substituted or unsubstituted alkyl functional group. In a preferred embodiment of the present invention, R^{I} is a linear or branched alkyl radical having 5 to 30 carbon atoms, preferably 7 to 25 carbon atoms, and in particular 10 to 19 carbon atoms. Preferred functional groups R′ are selected from decyl, undecyl, dodecyl, tridecyl, tetradecyl, pentadecyl, hexadecyl, heptadecyl, octadecyl, nonadecyl functional groups and mixtures thereof, the representatives that have an even number of carbon atoms being preferred. Particularly preferred functional groups R′ are derived from fatty alcohols having 12 to 19 carbon atoms, for example from coconut fatty alcohol, tallow fatty alcohol, lauryl, myristyl, cetyl or stearyl alcohol, or from oxo alcohols having 10 to 19 carbon atoms.

XO in formula (T-2) is an ethylene oxide (EO) or a propylene oxide (PO) group, preferably an ethylene oxide group.

The index m in formula (T-2) is an integer from 1 to 50, preferably from 2 to 20, and more preferably from 2 to 10. In particular, m is 3, 4, 5, 6 or 7. The solid, viscoelastic filling substance according to the invention may contain mixtures of nonionic surfactants which have different degrees of ethoxylation.

In summary, particularly preferred fatty alcohol alkoxylates are those of formula (T-3)

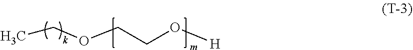

where k=9 to 17, and m=3, 4, 5, 6, or 7. Very particularly preferred representatives are fatty alcohols having 10 to 18 carbon atoms and 7 EO (k=11 to 17, m=7).

Fatty alcohol ethoxylates of this kind are available under the trade names Dehydol® LT7 (BASF), Lutensol® A07 (BASF), Lutensol® M7 (BASF), and Neodol® 45-7 (Shell Chemicals).

Particularly preferably, the solid, viscoelastic filling substances according to the invention contain nonionic surfactants from the group of alkoxylated alcohols. Nonionic surfactants that are preferably used are alkoxylated, advantageously ethoxylated, in particular primary alcohols having preferably 8 to 18 C atoms and, on average, 1 to 12 mol ethylene oxide (EO) per mol of alcohol, in which the alcohol functional group can be linear or preferably methyl-branched in the 2 position, or can contain linear and methyl-branched functional groups in admixture, as are usually present in oxo alcohol functional groups. However, alcohol ethoxylates having linear functional groups of alcohols of native origin having 12 to 18 C atoms, for example from coconut, palm, tallow fatty or oleyl alcohol, and an average of 2 to 8 EO per mol of alcohol, are particularly preferred. Preferred ethoxylated alcohols include, for example C₁₂₋₁₄-alcohols having 3 EO or 4 EO, C₈₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol with 3 EO and C₁₂₋₁₈-alcohol with 5 EO.

Preferred alcohol ethoxylates have a narrowed homologue distribution (narrow range ethoxylates, NRE). In addition to these nonionic surfactants, fatty alcohols having more than 12 EO can also be used in particular as cleaning agents for automatic dishwashing. Examples of these are tallow fatty alcohols with 14 EO, 25 EO, 30 EO, or 40 EO.

Ethoxylated nonionic surfactants are particularly preferably used which were obtained from C₆₋₂₀ monohydroxy alkanols or C₆₋₂₀ alkyl phenols or C₁₆₋₂₀ fatty alcohols and more than 12 mol, preferably more than 15 mol, and in particular more than 20 mol, ethylene oxide per mol of alcohol. A particularly preferred nonionic surfactant is obtained from a straight-chain fatty alcohol having 16 to 20 carbon atoms (C₁₆₋₂₀ alcohol), preferably from a C₁₈ alcohol and at least 12 mol, preferably at least 15 mol and in particular at least 20 mol, ethylene oxide. Of these, what are referred to as “narrow range ethoxylates” are particularly preferred.

Surfactants that are preferably used come from the group of the alkoxylated nonionic surfactants, in particular the ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are also characterized by good foam control.

In the context of the present invention, low-foaming nonionic surfactants which have alternating ethylene oxide and alkylene oxide units have been found to be particularly preferred nonionic surfactants, in particular for cleaning agents for automatic dishwashing. Among these, in turn, surfactants having EO-AO-EO-AO blocks are preferred, with one to ten EO groups or AO groups being bonded to one another before a block of the other group follows. Here, nonionic surfactants of general formula (T-4) are preferred

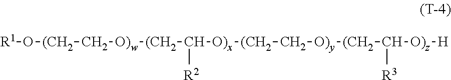

are preferred, in which R¹ represents a straight-chain or branched, saturated or mono- or polyunsaturated C₆₋₂₄ alkyl or alkenyl functional group; each R₂ and R₃ group is selected, independently of one another, from —CH₃, —CH₂CH₃, —CH₂CH₂—CH₃, —CH(CH₃)₂; and the indices w, x, y and z represent, independently of one another, integers from 1 to 6.

Preferred nonionic surfactants of the above formula can be prepared using known methods, from the corresponding alcohols R¹—OH and ethylene or alkylene oxide. The R¹ radical in the above formula can vary depending on the origin of the alcohol. If native sources are used, the R¹ functional group has an even number of carbon atoms and is generally unbranched, with the linear functional groups of alcohols of native origin having 12 to 18 C atoms, such as coconut, palm, tallow fatty or oleyl alcohol, for example, being preferred. Some examples of alcohols that are available from synthetic sources are the Guerbet alcohols or functional groups that are methyl-branched or linear and methyl-branched in the 2 position in admixture, such as those usually present in oxo alcohol functional groups. Irrespective of the approach taken in the production of the alcohol used in the nonionic surfactants contained in the viscoelastic, solid filling substance, nonionic surfactants are preferred in which R¹ represents an alkyl functional group having 6 to 24, preferably 8 to 20, particularly preferably 9 to 15, and in particular 9 to 11, carbon atoms in the above formula.

Besides propylene oxide, butylene oxide in particular is worthy of consideration as an alkylene oxide unit that is contained alternately with the ethylene oxide unit in the preferred nonionic surfactants. However, other alkylene oxides in which R² and R³ are selected, independently of one another, from —CH₂CH₂—CH₃ and —CH(CH₃)₂ are also suitable. Preferably, nonionic surfactants of the above formula are used in which R² and R³ represent a —CH₃ functional group; w and x represent, independently of one another, values of 3 or 4; and y and z represent, independently of one another, values of 1 or 2.

Further preferably used nonionic surfactants, in particular for viscoelastic, solid filling substances for use as cleaning agents for automatic dishwashing, are nonionic surfactants of general formula (T-5)

R¹O(AlkO)ₓM(OAlk)_{y}OR² (T-5)

where R¹ and R² represent, independently of one another, a branched or unbranched, saturated or unsaturated, optionally hydroxylated alkyl radical having 4 to 22 carbon atoms; Alk represents a branched or unbranched alkyl radical having 2 to 4 carbon atoms; x and y represent, independently of one another, values of between 1 and 70; and M represents an alkyl radical from the group CH₂, CHR³, CR³R⁴, CH₂CHR³ and CHR³CHR⁴, where R³ and R⁴ represent, independently of one another, a branched or unbranched, saturated or unsaturated alkyl radical having 1 to 18 carbon atoms.

Preferred in this case are nonionic surfactants of general formula (T-6)

R¹—CH(OH)CH₂—O(CH₂CH₂O)ₓCH₂CHR(OCH₂CH₂)_{y}—CH₂CH(OH)—R² (T-6),

where R, R¹ and R², independently of one another, represent an alkyl radical or alkenyl radical having 6 to 22 carbon atoms; x and y, independently of one another, represent values of between 1 and 40.

Preferred in this case are, in particular, compounds of general formula (T-7)

R¹—CH(OH)CH₂—O(CH₂CH₂O)ₓCH₂CHR(OCH₂CH₂)_{y}O—CH₂CH(OH)—R² (T-7)

in which R represents a linear, saturated alkyl radical having 8 to 16 carbon atoms, preferably 10 to 14 carbon atoms, and R¹ and R² represent, independently of one another, an alkyl radical or alkenyl radical having 6 to 22 carbon atoms, and n and m represent, independently of one another, values of from 20 to 30. Such compounds can be obtained, for example, by reacting alkyl diols HO—CHR—CH₂—OH with ethylene oxide, a reaction with an alkyl epoxide being performed subsequently in order to close the free OH functions during formation of a dihydroxy ether.

Preferred nonionic surfactants are in this case, in particular for viscoelastic, solid filling substances for use as cleaning agents for automatic dishwashing, those of general formula (T-8)

R¹—CH(OH)CH₂O-(AO)_{w}-(AO)ₓ-(A″O)_{y}-(A′″O)_{z}—R² (T-8)

where
R¹ represents a straight-chain or branched, saturated or mono- or polyunsaturated C₆₋₂₄-alkyl or alkenyl radical;
R² represents hydrogen or a linear or branched hydrocarbon radical having 2 to 26 carbon atoms;
A, A′, A″ and A′″ represent, independently of one another, a functional group from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y and z represent values between 0.5 and 120, it being also possible for x, y and/or z to be 0.

By adding the above-mentioned nonionic surfactants of general formula (T-8)

R¹—CH(OH)CH₂O-(AO)_{w}-(A′O)ₓ-(A″O)_{y}-(A′″O)_{z}—R² (T-8)

hereinafter also referred to as “hydroxy mixed ethers,” the cleaning performance of preparations according to the invention can surprisingly be significantly improved, specifically in comparison to systems that contain alternative nonionic surfactants, such as those from the group of polyalkoxylated fatty alcohols.

By using these nonionic surfactants having one or more free hydroxyl groups on one or both terminal alkyl functional groups, the stability of the enzymes that may be additionally contained in the viscoelastic, solid filling substances according to the invention can be significantly improved.

In particular, those end-capped poly(oxyalkylated) nonionic surfactants are preferred, in particular for cleaning agents for automatic dishwashing, which, according to the following formula (T-10)

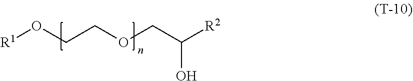

in addition to a radical R¹, which represents linear or branched, saturated or unsaturated, aliphatic or aromatic hydrocarbon radicals having 2 to 30 carbon atoms, preferably having 4 to 22 carbon atoms, also have a linear or branched, saturated or unsaturated, aliphatic or aromatic hydrocarbon radical R² having 1 to 30 carbon atoms, where n represents values of between 1 and 90, preferably values of between 10 and 80, and in particular values of between 20 and 60. Surfactants of the above formula are particularly preferred in which R¹ represents C₇ to C₁₃, n represents a whole natural number from 16 to 28, and R² represents C₈ to C₁₂.

Surfactants of the formula are particularly preferred, in particular for viscoelastic, solid filling substances for use as cleaning agents for automatic dishwashing

R¹O[CH₂CH(CH₃)O]ₓ[CH₂CH₂O]_{y}CH₂CH(OH)R²,

in which R¹ represents a linear or branched aliphatic hydrocarbon functional group having 4 to 18 carbon atoms or mixtures thereof, R² denotes a linear or branched hydrocarbon functional group having 2 to 26 carbon atoms or mixtures thereof, x represents values of between 0.5 and 1.5, and y represents a value of at least 15. The group of these nonionic surfactants includes for example the C₂₋₂₆ fatty alcohol (PO)₁-(EO)₁₅₋₄₀-2-hydroxyalkyl ethers, in particular including the C₈₋₁₀ fatty alcohol (PO)₁-(EO)₂₂-2-hydroxydecyl ethers.

Preferred in particular are those end-group-capped poly(oxyalkylated) nonionic surfactants, in particular for viscoelastic, solid filling substances for use as cleaning agents for automatic dishwashing, which are of the formula

R¹O[CH₂CH₂O]ₓ[CH₂CH(R³)O]_{y}CH₂CH(OH)R²,

in which R¹ and R² represent, independently of one another, a linear or branched, saturated or mono- or polyunsaturated hydrocarbon functional group having 2 to 26 carbon atoms, R³ is selected, independently of one another, from —CH₃, —CH₂CH₃, —CH₂CH₂—CH₃, —CH(CH₃)₂, but preferably represents —CH₃, and x and y represent, independently of one another, values of between 1 and 32, with nonionic surfactants where R³=—CH₃ and having values for x of from 15 to 32 and for y of from 0.5 and 1.5 being very particularly preferred.

Further preferably used nonionic surfactants, in particular for viscoelastic, solid filling substances for use as cleaning agents for automatic dishwashing, are the end-capped poly(oxyalkylated) nonionic surfactants of the formula

R¹O[CH₂CH(R³)O]ₓ[CH₂]ₖCH(OH)[CH₂]ⱼOR²,

in which R¹ and R² represent linear or branched, saturated or unsaturated, aliphatic or aromatic hydrocarbon radicals having 1 to 30 carbon atoms, R³ represents H or a methyl, ethyl, n-propyl, iso-propyl, n-butyl, 2-butyl or 2-methyl-2-butyl radical, x represents values between 1 and 30, and k and j represent values between 1 and 12, preferably between 1 and 5. If the value x is >2, each R³ in the above formula R¹O[CH₂CH(R³)O]ₓ[CH₂]ₖCH(OH)[CH₂]OR² can be different. R¹ and R² are preferably linear or branched, saturated or unsaturated, aliphatic or aromatic hydrocarbon functional groups having 6 to 22 carbon atoms, with functional groups having 8 to 18 C atoms being particularly preferred. For the functional group R³, H, —CH₃ or —CH₂CH₃ are particularly preferred. Particularly preferred values for x are in the range of from 1 to 20, in particular from 6 to 15.

As described above, each R³ in the above formula can be different if x is >2. In this way, the alkylene oxide unit in square brackets can be varied. For example, if x represents 3, the functional group R³ can be selected in order to form ethylene oxide (R³=H) or propylene oxide (R³=CH₃) units, which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and can by all means be greater, in which case the range of variation increases as the values for x increase and includes a large number of (EO) groups combined with a small number of (PO) groups, for example, or vice versa.

Particularly preferred end-capped poly(oxyalkylated) alcohols of the above formula have values of k=1 and j=1, such that the previous formula is simplified to R¹O[CH₂CH(R³)O]ₓCH₂CH(OH)CH₂OR². In the formula mentioned last, R¹, R² and R³ are as defined above and x represents numbers from 1 to 30, preferably from 1 to 20, and in particular from 6 to 18. Surfactants in which the radicals R¹ and R² have 9 to 14 C atoms, R³ represents H, and x assumes values from 6 to 15 are particularly preferred. Finally, the nonionic surfactants of general formula R¹—CH(OH)CH₂O-(AO)_{w}—R² have proven to be particularly effective, in which
R¹ represents a straight-chain or branched, saturated or mono- or polyunsaturated C₆₋₂₄-alkyl or alkenyl radical;
R² represents a linear or branched hydrocarbon radical having 2 to 26 carbon atoms;
A represents a radical from the group CH₂CH₂, CH₂CH₂CH₂, CH₂CH(CH₃), preferably CH₂CH₂, and
w represents values between 1 and 120, preferably 10 to 80, particularly 20 to 40.

The group of these nonionic surfactants includes, for example, the C₄₋₂₂ fatty alcohol-(EO)₁₀₋₈₀-2-hydroxyalkyl ethers, in particular including the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers.

Furthermore, the viscoelastic, solid filling substance according to the invention may contain amine oxide as a nonionic surfactant. In principle, all the amine oxides found in the prior art for this purpose, i.e. compounds that have the formula R¹R²R³NO, where each of R¹, R² and R³ is, independently of one another, an optionally substituted hydrocarbon chain having 1 to 30 carbon atoms, can be used as the amine oxide. Amine oxides that are particularly preferably used are those in which R¹ is an alkyl having 12 to 18 carbon atoms and R² and R³ are, independently of one another, an alkyl having 1 to 4 carbon atoms, in particular alkyl dimethyl amine oxides having 12 to 18 carbon atoms. Examples of representatives of suitable amine oxides are N-coconut-alkyl-N,N-dimethyl amine oxide, N-tallow alkyl-N,N-dihydroxyethyl amine oxide, myristyl-/cetyl dimethyl amine oxide or lauryl dimethyl amine oxide.

Suitable nonionic surfactants include alkyl glycosides of general formula RO(G)ₓ, for example, in which R corresponds to a primary straight-chain or methyl-branched aliphatic radical, in particular an aliphatic radical that is methyl-branched in the 2 position, having 8 to 22, preferably 12 to 18, C atoms, and G is the symbol that represents a glycose unit having 5 or 6 C atoms, preferably glucose. The degree of oligomerization x, which indicates the distribution of monoglycosides and oligoglycosides, is any number between 1 and 10; x is preferably between 1.2 and 1.4.

Another class of preferably used nonionic surfactants, which are used either as the sole nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain.

Other suitable surfactants are the polyhydroxy fatty acid amides, which are known as PHFAs.

Other nonionic surfactants that can be used may be, for example,
polyol fatty acid esters,
alkoxylated triglycerides,
alkoxylated fatty acid alkyl esters of formula R³CO—(OCH₂CHR⁴)_{w}OR⁵,
in which R³CO represents a linear or branched, saturated and/or unsaturated acyl functional group having 6 to 22 carbon atoms, R⁴ represents hydrogen or methyl, and R⁵ represents linear or branched alkyl functional groups having 1 to 4 carbon atoms, and w is 1 to 20,
hydroxy mixed ethers,
sorbitan fatty acid esters and addition products of ethylene oxide to sorbitan fatty acid esters such as the polysorbates,
sugar fatty acid esters and addition products of ethylene oxide to sugar fatty acid esters,
addition products of ethylene oxide to fatty acid alkanolamides and fatty amines, or
fatty acid-N-alkyl glucamides.

The viscoelastic, solid filling substance according to the invention described herein may also contain a plurality of the nonionic surfactants described above.

According to the invention, particularly preferred viscoelastic, solid filling substances, in particular as textile washing agents, each contain, based on the total weight, a total amount of
10 to 60% by weight, in particular 25 to 40% by weight, of at least one anionic surfactant, and
2 to 35% by weight, in particular 18 to 28% by weight, of at least one nonionic surfactant.

Very particularly preferred viscoelastic, solid filling substances according to the invention for use as textile washing agents contain, according to the invention, at least one surfactant combination as described below for the compositions (A) to (D):
(A) viscoelastic, solid filling substance containing, as a surfactant, in each case based on the total weight of the viscoelastic, solid filling substance, at least a total amount of
   10 to 60 wt. % of at least one anionic surfactant, at least one C₉₋₁₃-alkyl benzene sulfonate being contained as an anionic surfactant, and
   2 to 35 wt. % of at least one nonionic surfactant, at least one alkoxylated alcohol having 8 to 18 carbon atoms and on average 4 to 12 mol ethylene oxide (EO) per mol of alcohol being contained as a nonionic surfactant.
(B) viscoelastic, solid filling substance containing, as a surfactant, in each case based on the total weight of the viscoelastic, solid filling substance, at least a total amount of
   10 to 60 wt. % of at least one anionic surfactant, at least 5 to 60 wt. % of at least one C₉₋₁₃-alkyl benzene sulfonate being contained as an anionic surfactant, and
   2 to 35 wt. % of at least one nonionic surfactant, at least 2 to 35 wt. % of at least one alkoxylated alcohol having 8 to 18 carbon atoms and on average 4 to 12 mol ethylene oxide (EO) per mol of alcohol being contained as a nonionic surfactant.
(C) viscoelastic, solid filling substance containing, as a surfactant, in each case based on the total weight of the viscoelastic, solid filling substance, at least a total amount of
   25 to 40 wt. % of at least one anionic surfactant, at least one C₉₋₁₃-alkyl benzene sulfonate being contained as an anionic surfactant, and
   18 to 28 wt. % of at least one nonionic surfactant, at least one alkoxylated alcohol having 8 to 18 carbon atoms and on average 4 to 12 mol ethylene oxide (EO) per mol of alcohol being contained as a nonionic surfactant.
(D) viscoelastic, solid filling substance containing, as a surfactant, in each case based on the total weight of the viscoelastic, solid filling substance, at least a total amount of
   25 to 40 wt. % of at least one anionic surfactant, at least 25 to 40 wt. % of at least one C₉₋₁₃-alkyl benzene sulfonate being contained as an anionic surfactant, and
   18 to 28 wt. % of at least one nonionic surfactant, at least 18 to 28 wt. % of at least one alkoxylated alcohol having 8 to 18 carbon atoms and on average 4 to 12 mol ethylene oxide (EO) per mol of alcohol being contained as a nonionic surfactant.

When providing all of the aforementioned solid, viscoelastic filling substances with a specific amount of selected surfactant, the amounts of the individual surfactant components are of course to be selected within the stated quantity ranges of the individual surfactant components so that the specified total amount of surfactant is adhered to.

Preferred viscoelastic and solid filling substances are characterized in that, based on their total weight, the organic gelator compound is contained in the above-mentioned filling substance in a total amount of 0.5 to 10.0 wt. %, in particular 0.8 to 5.0 wt. %, more preferably between 1.0 wt. % and 4.5 wt. %, very particularly preferably between 1.0 and 4.0 wt. %.

In preferred viscoelastic and solid filling substances, the organic gelator compound is selected from benzylidene alditol compound, diketopiperazine compound, dibenzylcystine compound, hydrogenated castor oil, hydroxystearic acid, N—(C₈-C₂₄)-hydrocarbyl glyconamide, or mixtures thereof. A selection from at least one benzylidene alditol compound is particularly preferred.

Very particularly preferred viscoelastic and solid filling substances are characterized in that the above-mentioned filling substance contains at least one benzylidene alditol compound of the formula (I) as the organic gelator compound

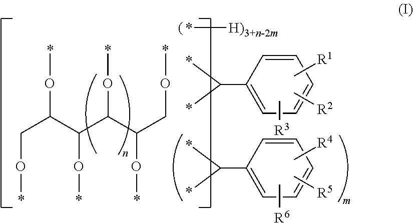

wherein
*- represents a covalent single bond between an oxygen atom of the alditol backbone and the provided functional group,
n represents 0 or 1, preferably 1,
m represents 0 or 1, preferably 1,
R¹, R² and R³ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, a —NH—C(═O)—(C₂-C₄-alkyl) group, a C₁-C₄ alkoxy group, a C₁-C₄ alkoxy C₂-C₄ alkyl group, with two of the functional groups forming, together with the remainder of the molecule, a 5-membered or 6-membered ring,
R⁴, R⁵, and R⁶ independently represent a hydrogen atom, a halogen atom, a C₁-C₄alkyl group, a cyano group, a nitro group, an amino group, a carboxyl group, a hydroxyl group, a —C(═O)—NH—NH₂ group, a —NH—C(═O)—(C₂-C₄-alkyl) group, a C₁-C₄-alkoxy group, a C₁-C₄-alkoxy-C₂-C₄-alkyl group, wherein two of the radicals form, together with the remainder of the molecule, a 5- or 6-membered ring.

Due to the stereochemistry of the alditols, it should be mentioned that the above-mentioned benzylidene alditols according to the invention are suitable in the L configuration or in the D configuration or in a mixture of the two. Due to natural availability, the benzylidene alditol compounds are preferably used according to the invention in the D configuration. It has been found to be preferable for the alditol backbone of the benzylidene alditol compound according to formula (I) contained in the above-mentioned filling substance to be derived from D-glucitol, D-mannitol, D-arabinitol, D-ribitol, D-xylitol, L-glucitol, L-mannitol, L-arabinitol, L-ribitol, or L-xylitol.

Particularly preferred are those above-mentioned filling substances which are characterized in that R¹, R², R³, R⁴, R⁵ and R⁶ according to the benzylidene alditol compound of formula (I) mean, independently of one another, a hydrogen atom, methyl, ethyl, chlorine, fluorine, or methoxy, preferably a hydrogen atom.

n according to benzylidene alditol compound of formula (I) preferably represents 1.

m according to benzylidene alditol compound formula (I) preferably represents 1.

More than very particularly preferably, the viscoelastic and solid filling substance according to the invention contains, as a benzylidene alditol compound of formula (I), at least one compound of formula (I-1)

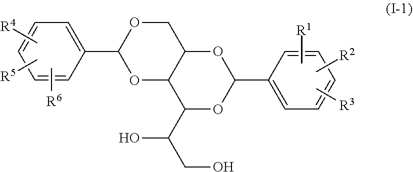

where R¹, R², R³, R⁴, R⁵ and R⁶ are as defined in formula (I). Most preferably, according to formula (I-1), R¹, R², R³, R⁴, R⁵ and R⁶ represent, independently of one another, a hydrogen atom, methyl, ethyl, chlorine, fluorine, or methoxy, preferably a hydrogen atom.

Most preferably, the benzylidene alditol compound of formula (I) is selected from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-di-O-(3,4-dimethylbenzylidene)-D-sorbitol, or mixtures thereof.

Preferred viscoelastic, solid filling substances contain at least one 2,5-diketopiperazine compound of the formula (I) as the organic gelator compound

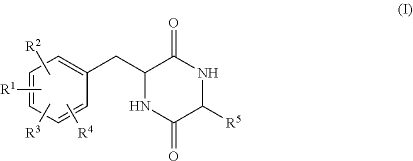

wherein
R¹, R², R³ and R⁴ independently of one another represent a hydrogen atom, a hydroxy group, a (C₁-C₆)-alkyl group, a (C₂-C₆)-alkenyl group, a (C₂-C₆)-acyl group, a (C₂-C₆)-acyloxy group, a (C₁-C₆)-alkoxy group, an amino group, a (C₂-C₆)-acylamino group, a (C₁-C₆)-alkylaminocarbonyl group, an aryl group, an aroyl group, an aroyloxy group, an aryloxy group, an aryl (C₁-C₄)-alkyloxy group, an aryl (C₁-C₃)-alkyl group, a heteroaryl group, a heteroaryl (C₁-C₃)-alkyl group, a (C₁-C₄)-hydroxyalkyl group, a (C₁-C₄)-aminoalkyl group, a carboxy(C₁-C₃)-alkyl group, wherein at least two of the radicals R¹ to R⁴ can form a 5- or 6-membered ring together with the rest of the molecule,
R⁵ stands for a hydrogen atom, a linear (C₁ to C₆)-alkyl group, a branched (C₃ to C₆)-alkyl group, a (C₃ to C₆)-cycloalkyl group, a (C₂-C₆)-alkenyl group, a (C₂-C₆)-alkynyl group, a (C₁-C₄)-hydroxyalkyl group, a (C₁-C₄)-alkoxy-(C₁-C₄)-alkyl group, a (C₁-C₄)-acyloxy-(C₁-C₄)-alkyl group, an aryloxy-(C₁-C₄)-alkyl group, an O-(aryl-(C₁-C₄)-alkyl)oxy-(C₁-C₄)-alkyl group, a (C₁-C₄)-alkylsulphanyl-(C₁-C₄)-alkyl group, an aryl group, an aryl-(C₁-C₃)-alkyl group, a heteroaryl group, a hetroaryl-(C₁-C₃)-alkyl group, a (C₁-C₄)-hydroxyalkyl group, a (C₁-C₄)-aminoalkyl group, an N—(C₁-C₄)-alkylamino-(C₁-C₄)-alkyl group, an N,N—(C₁-C₄)-dialkylamino-(C₁-C₄)-alkyl group, an N—(C₂-C₈)-acylamino-(C₁-C₄)-alkyl group, an N—(C₂-C₈)-acyl-N—(C₁-C₄)-alkylamino-(C₁-C₄)-alkyl group, an N—(C₂-C₈)-Aroyl-N—(C₁-C₄)-alkylamino-(C₁-C₄)-alkyl group, an N,N—(C₂-C₈)-diacylamino-(C₁-C₄)-alkyl group, an N-(aryl-(C₁-C₄)-alkyl)amino-(C₁-C₄)-alkyl group, an N,N-di(aryl-(C₁-C₄)-alkyl)amino-(C₁-C₄)-alkyl group, a (C₁-C₄)-carboxyalkyl group, a (C₁-C₄)-alkoxycarbonyl-(C₁-C₃)-alkyl group, a (C₁-C₄)-acyloxy-(C₁-C₃)-alkyl group, a guanidino-(C₁-C₃)-alkyl group, an aminocarbonyl-(C₁-C₄)-alkyl group, an N—(C₁-C₄)-alkylaminocarbonyl-(C₁-C₄)-alkyl group, an N,N-Di((C₁-C₄)-alkyl) aminocarbonyl-(C₁-C₄)-alkyl group, an N—(C₂-C₈)-acylaminocarbonyl-(C₁-C₄)-alkyl group, an N,N—(C₂-C₈)-diacylaminocarbonyl-(C₁-C₄)-alkyl group, an N—(C₂-C₈)-acyl-N—(C₁-C₄)-alkylaminocarbonyl-(C₁-C₄)-alkyl group, an N-(aryl-(C₁-C₄)-alkyl) aminocarbonyl-(C₁-C₄)-alkyl group, an N-(aryl-(C₁-C₄)-alkyl)-N—(C₁-C₆)-alkylaminocarbonyl-(C₁-C₄)-alkyl group, or an N,N-di(aryl-(C₁-C₄)-alkyl)aminocarbonyl-(C₁-C₄)-alkyl group.

It is preferred according to the invention if R³ and R⁴ according to formula (II) represent a hydrogen atom. According to the invention it is particularly preferred if R², R³ and R⁴ according to formula (II) represent a hydrogen atom. Very particularly preferred viscoelastic and solid filling substances according to the invention therefore contain at least one 2,5-diketopiperazine compound according to formula (II-a)

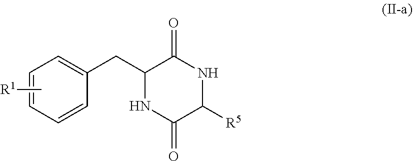

wherein R¹ and R⁵ are defined under formula (II) (vide supra).

It has been found to be preferred if the radical R¹ according to formula (II) and according to formula (II-a) binds in the para position of the phenyl ring. For the purposes of the present invention, preference is therefore given to filling substances according to the invention which contain at least one 2,5-diketopiperazine compound according to formula (II-b),

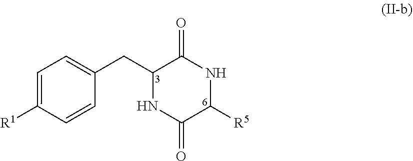

wherein R¹ and R⁵ are defined as above under formula (II) (vide supra). The numbers 3 and 6 positioned on the ring atoms in formula (II-b) only mark positions 3 and 6 of the diketopiperazine ring, as they are generally used in the scope of the invention for naming all 2,5-diketopiperazines according to the invention.

The 2,5-diketopiperazine compounds of the formula (II) have centers of chirality at least on the carbon atoms in positions 3 and 6 of the 2,5-diketopiperazine ring. The numbering of ring positions 3 and 6 was illustrated by way of example in formula (II-b). The 2,5-diketopiperazine compound of the formula (II) of the filling substance according to the invention is preferably the configuration isomer 3 S, 6S, 3R, 6S, 3 S, 6R based on the stereochemistry of the carbon atoms at the 3 and 6 position of the 2,5-diketopiperazine ring, 3R, 6R, or mixtures thereof, particularly preferably 3S, 6S.

Preferred portion packs contain in the above-mentioned filling substance at least one 2,5-diketopiperazine compound of the formula (II) as an organic gelator compound selected from 3-benzyl-6-carboxyethyl-2,5-diketopiperazine, 3-benzyl-6-carboxymethyl-2,5-diketopiperazine, 3-benzyl-6-(p-hydroxybenzyl)-2,5-diketopiperazine, 3-benzyl-6-iso-propyl-2,5-diketopiperazine, 3-benzyl-6-(4-aminobutyl)-2,5-diketopiperazine, 3,6-di(benzyl)-2,5-diketopiperazine, 3,6-di(p-hydroxybenzyl)-2,5-diketopiperazine, 3,6-di(p-(benzyloxy)benzyl)-2,5-diketopiperazine, 3-benzyl-6-(4-imidazolyl)methyl-2,5-diketopiperazine, 3-benzyl-6-methyl-2,5-diketopiperazine, 3-benzyl-6-(2-(benzyloxycarbonyl)ethyl)-2,5-diketopiperazine, or mixtures thereof. In turn, compounds with the aforementioned configuration isomers are preferably suitable for selection.

It is also possible for the portion packs according to the invention to contain at least one diarylamidocystine compound of the formula (III) in their above-mentioned filling substance as the organic gelator compound

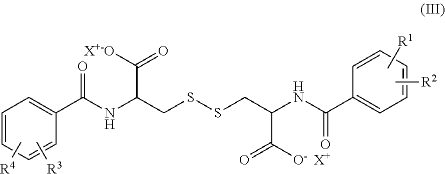

wherein
X⁺, independently of each other, stands for a hydrogen atom or an equivalent of a cation,
R¹, R², R³, and R⁴, independently of each other, stand for a hydrogen atom, a halogen atom, a C₁-C₄ alkyl group, a C₁-C₄ alkoxy group, a C₂-C₄ hydroxyalkyl group, a hydroxyl group, an amino group, an N—(C₁-C₄ alkyl)amino group, an N,N-Di(C₁-C₄ alkyl)amino group, an N—(C₂-C₄ hydroxyalkyl)amino group, an N,N-Di(C₂-C₄ hydroxyalkyl)amino group, or R¹ with R² or R³ with R⁴ forms a 5- or 6-segment annulated ring, which in turn can each be substituted with at least one group from C₁-C₄ alkyl group, C₁-C₄ alkoxy group, C₂-C₄ hydroxyalkyl group, hydroxyl group, amino group, N—(C₁-C₄ alkyl)amino group, N,N-Di(C₁-C₄ alkyl)amino group, N—(C₂-C₄ hydroxyalkyl)amino group, N,N-Di(C₂-C₄ hydroxyalkyl)amino group.

Each of the stereocenters contained in the compound of the formula (III) can independently represent the L or D stereoisomer. It is preferable according to the invention for the above-mentioned cystine compound of formula (III) to be derived from the L stereoisomer of the cysteine.

The above-mentioned filling substances can contain at least one compound of formula (III), in which R¹, R², R³, and R⁴, independently of each other, stand for a hydrogen atom, a halogen atom, a C₁-C₄ alkyl group, a C₁-C₄ alkoxy group, a C₂-C₄ hydroxyalkyl group, a hydroxyl group, or R¹ with R² or R³ with R⁴ forms a 5- or 6-segment annulated ring, which in turn can each be substituted with at least one group from C₁-C₄ alkyl group, C₁-C₄ alkoxy group, C₂-C₄ hydroxyalkyl group, or hydroxyl group. In particular, those filling substances which contain N,N′-dibenzoylcystine (R¹=R²=R³=R⁴ hydrogen atom; X⁺=independently of each other, for a hydrogen atom or an equivalent of a cation), in particular N,N′-dibenzoyl-L-cystine, as a diarylamidocystine compound of formula (III) are particularly suitable.

The N—(C₅-C₂₄)-hydrocarbyl glyconamide compounds suitable as organic gelator compounds preferably have the formula (IV)

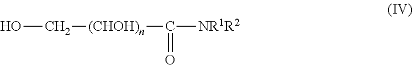

wherein
n is 2 to 4, preferably 3 or 4, in particular 4;
R¹ is selected from hydrogen, C₁-C₁₆ alkyl radicals, C₁-C₃ hydroxy or methoxyalkyl radicals, preferably C₁-C₃ alkyl, hydroxyalkyl, or methoxyalkyl radicals, particularly preferably methyl;
R² is selected from C₅-C₂₄ alkyl radicals, C₅-C₂₄ monoalkenyl radicals, C₅-C₂₄ dialkenyl radicals, C₅-C₂₄ trialkenyl radicals, C₅-C₂₄ hydroxyalkyl radicals, C₅-C₂₄-hydroxyalkenyl residues, C₁-C₃ hydroxyalkyl residues or methoxy-C₁-C₃-alkyl residues, preferably C₈-C₁₈ alkyl residues and mixtures thereof, more preferably C₈, C₁₀, C₁₂, C₁₄, C₁₆, and C₁₈ alkyl radicals and mixtures thereof, most preferably C₁₂ and C₁₄ alkyl radicals or a mixture thereof.

In particularly preferred embodiments, the remainder

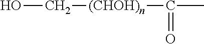

is a residue derived from a glycuronic acid, in particular the glycuronic acid of a hexose (n=4). In particular, glucuronic acid should be mentioned as a preferred residue. R¹ is preferably H or a short-chain alkyl radical, in particular methyl. R² is preferably a long-chain alkyl radical, for example a C₈-C₁₈ alkyl radical.

Compounds of the formula (IV-1) are therefore very particularly preferred

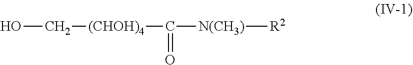

where R² has the meanings given for formula (IV).

The filling substance according to the invention of the portion pack according to the invention optionally contains water. It is preferred if in the above-mentioned filling substance water is contained in a total amount of 0 to 30 wt. %, more preferably 0 and 30 wt. %, particularly preferably 0 to 25 wt. %, more preferably 0 and 25 wt. %, very particularly preferably 0 to 20 wt. %, more preferably 0 and 20 wt. %, based on the total weight of the filling substance. The proportion of water in the filling substance is very particularly preferably 20 wt. % or less, more preferably 15 wt. % or less, even more preferably 12 wt. % or less, in particular between 4 and 11 wt. %. The quantities in wt. % refer to the total weight of the filling substance in each case.

Viscoelastic, solid filling substances that can be used with preference are characterized in that they additionally contain at least one organic solvent with a molecular weight of at most 500 g/mol. It is again particularly preferred if the above-mentioned organic solvent is selected from (C₂-C₈)-alkanols with at least one hydroxyl group (very particularly preferably from ethanol, ethylene glycol, 1,2-propanediol, glycerin, 1,3-propanediol, n-propanol, isopropanol, 1,1,1-trimethylolpropane, 2-methyl-1,3-propanediol, 2-hydroxymethyl-1,3-propanediol), triethylene glycol, butyl diglycol, polyethylene glycols having a weight-average molar mass M_{w} of at most 500 g/mol, glycerol carbonate, propylene carbonate, 1-methoxy-2-propanol, 3-methoxy-3-methyl-1-butanol, butyl lactate, 2-isobutyl-2-methyl-4-hydroxymethyl-1,3-dioxolane, 2,2-dimethyl-4-hydroxymethyl-1,3-dioxolane, dipropylene glycol, or mixtures thereof.

Said organic solvent is particularly preferably contained in the above-mentioned at least one filling substance in a total amount of 5 to 40 wt. %, in particular 10 to 35 wt. %, based on the total weight of the above-mentioned at least one filling substance.

It is preferred according to the invention if the viscoelastic and solid filling substance is present in the portion pack as a molded body.

A molded body is a single body that stabilizes itself in the shape imparted to it. This dimensionally stable body is formed from a molding compound (e.g., a composition) in such a way that this molding compound is deliberately brought into a predetermined shape, for example, by pouring a liquid composition into a casting mold (for example, the shell according to the invention) and then curing the liquid composition, for example in the scope of a sol-gel process. All conceivable shapes are possible, such as spheres, cubes, cuboids, round discs, tubs, bowls, prisms, octas, tetrahedra, egg shapes, dogs, cats, mice, horses, torsos, busts, pillows, automobiles, oval discs with an embossed trademark, and much more.

It is preferred according to the invention if the molded body of the viscoelastic, solid filling substance has a weight of at least 1 g, preferably at least 5 g, particularly preferably at least 10 g.

It is preferred according to the invention if the molded body according to the invention of the viscoelastic, solid filling substance has a weight of at most 80 g, in particular at most 70 g, particularly preferably at most 50 g, very particularly preferably at most 40 g, most preferably at most 30 g. In this context, the aforementioned minimum weights of the molded body are particularly preferred.

The molded body of the viscoelastic, solid filling substance very particularly preferably has a weight of 10 to 80 g, in particular 10 to 70 g, more preferably 10 to 50 g, most preferably 10 to 30 g, for example 15 g or 25 g. It is again preferred if the above-mentioned molded body contains surfactant in the total amounts marked as preferred (vide supra).

According to the invention, preferred viscoelastic, solid filling substances additionally contain at least one active ingredient selected from polyalkoxylated polyamine, soil-release active ingredient, enzyme, builders, complexing agents, optical brighteners (preferably in portion packs for textile washing), pH adjusters, perfume, dyes, dye transfer inhibitors or the mixtures thereof.

It is preferred according to the invention if the viscoelastic, solid filling substance according to the invention (in particular as a textile washing agent) contains at least one polyalkoxylated polyamine in addition to the surfactant.

In the scope of the present invention and its individual aspects, the polyalkoxylated polyamine is a polymer having an N-atom-containing backbone which carries polyalkoxy groups on the N atoms. The polyamine has primary amino functions at the ends (terminus and/or side chains) and preferably both secondary and tertiary amino functions internally; optionally, it may also have merely secondary amino functions internally, such that a linear polyamine, and not a branched chain polyamine, is produced. The ratio of primary to secondary amino groups in the polyamine is preferably in the range of from 1:0.5 to 1:1.5, in particular in the range of from 1:0.7 to 1:1. The ratio of primary to tertiary amino groups in the polyamine is preferably in the range of from 1:0.2 to 1:1, in particular in the range of from 1:0.5 to 1:0.8. The polyamine preferably has an average molar mass in the range of from 500 g/mol to 50,000 g/mol, in particular from 550 g/mol to 5,000 g/mol. The N atoms in the polyamine are separated from one another by alkylene groups, preferably by alkylene groups having 2 to 12 C atoms, in particular 2 to 6 C atoms, although it is not necessary for all the alkylene groups to have the same number of C atoms. Ethylene groups, 1,2-propylene groups, 1,3-propylene groups, and mixtures thereof are particularly preferred. Polyamines which carry ethylene groups as the above-mentioned alkylene group are also referred to as polyethyleneimine or PEI. PEI is a polymer that is particularly preferred according to the invention and has an N-atom-containing backbone.

The primary amino functions in the polyamine can carry 1 or 2 polyalkoxy groups and the secondary amino functions can carry 1 polyalkoxy group, although it is not necessary for every amino function to be alkoxy group-substituted. The average number of alkoxy groups per primary and secondary amino function in the polyalkoxylated polyamine is preferably from 1 to 100, in particular from 5 to 50. The alkoxy groups in the polyalkoxylated polyamine are preferably polypropoxy groups which are directly bound to N atoms, and/or polyethoxy groups which are bound to potentially present propoxy functional groups and to N atoms which do not carry propoxy groups.

Polyethoxylated polyamines are obtained by reacting polyamines with ethylene oxide (abbreviated to EO). The polyalkoxylated polyamines containing ethoxy and propoxy groups are preferably obtainable by reacting polyamines with propylene oxide (abbreviated to PO) and subsequent reaction with ethylene oxide.

The average number of propoxy groups per primary and secondary amino function in the polyalkoxylated polyamine is preferably from 1 to 40, in particular from 5 to 20.

The average number of ethoxy groups per primary and secondary amino function in the polyalkoxylated polyamine is preferably from 10 to 60, in particular from 15 to 30.

If desired, the terminal OH function polyalkoxy substituents in the polyalkoxylated polyamine can be partially or completely etherified with a C₁-C₁₀ alkyl group, in particular a C₁-C₃ alkyl group.

Polyalkoxylated polyamines which are particularly preferred according to the invention can be selected from polyamine reacted with 45EO per primary and secondary amino function, PEIs reacted with 43EO per primary and secondary amino function, PEIs reacted with 15EO+5PO per primary and secondary amino function, PEIs reacted with 15PO+30EO per primary and secondary amino function, PEIs reacted with 5PO+39.5EO per primary and secondary amino function, PEIs reacted with 5PO+15EO per primary and secondary amino function, PEIs reacted with 10PO+35EO per primary and secondary amino function, PEIs reacted with 15PO+30EO per primary and secondary amino function and PEIs reacted with 15PO+5EO per primary and secondary amino function. A very particularly preferred alkoxylated polyamine is PEI having a content of from 10 to 20 nitrogen atoms reacted with 20 units of EO per primary or secondary amino function of the polyamine.

A further preferred subject of the invention is the use of polyalkoxylated polyamines which can be obtained by reacting polyamines with ethylene oxide and optionally also propylene oxide. If polyamines polyalkoxylated with ethylene oxide and propylene oxide are used, the proportion of propylene oxide in terms of the total amount of the alkylene oxide is preferably from 2 mol. % to 18 mol. %, in particular from 8 mol. % to 15 mol. %.

The viscoelastic, solid filling substance according to the invention additionally contains preferably, based on the weight thereof, polyalkoxylated polyamines, in a total amount of from 0.5 to 12 wt. %, in particular from 5.0 to 9.0 wt. %.

In a further preferred embodiment, the viscoelastic, solid filling substance according to the invention, in particular as a textile washing agent, additionally contains at least one soil release active ingredient. Substances which allow the removal of dirt are often referred to as soil-release active ingredients or as soil repellents since they are capable of making the treated surface, preferably textiles, repellant to soil. Owing to their chemical similarity to polyester fibers, particularly effective active ingredients which allow the removal of dirt, but can also exhibit the desired effect on fabrics made of other materials, are copolyesters containing dicarboxylic acid units, alkylene glycol units and polyalkylene glycol units. Such polyesters which allow the removal of dirt and the use thereof, preferably in washing agents for textiles, have long been known.

For example, polymers of ethylene terephthalate and polyethylene oxide terephthalate in which the polyethylene glycol units have molecular weights of from 750 to 5,000 and the molar ratio of ethylene terephthalate to polyethylene oxide terephthalate is from 50:50 to 90:10, and the use thereof in washing agents are described in the German patent DE 28 57 292. Polymers that have a molecular weight of from 15,000 to 50,000 and consist of ethylene terephthalate and polyethylene oxide terephthalate in which the polyethylene glycol units have molecular weights of from 1,000 to 10,000 and the molar ratio of ethylene terephthalate to polyethylene oxide terephthalate is from 2:1 to 6:1 can be used in washing agents according to the German laid-open application DE 33 24 258. European patent EP 066 944 relates to textile treatment agents containing a copolyester of ethylene glycol, polyethylene glycol, aromatic dicarboxylic acid and sulfonated aromatic dicarboxylic acid in certain molar ratios. European patent EP 185 427 discloses polyesters that are end-capped with methyl or ethyl groups and have ethylene and/or propylene terephthalate and polyethylene oxide terephthalate units, and washing agents containing soil-release polymers of this kind. European patent EP 241 984 relates to a polyester which, in addition to oxyethylene groups and terephthalic acid units, also contains substituted ethylene units and glycerol units. European patent EP 241 985 discloses polyesters which, in addition to oxyethylene groups and terephthalic acid units, contain 1,2-propylene, 1,2-butylene and/or 3-methoxy-1,2-propylene groups and glycerol units, and which are end-capped with C₁ to C₄ alkyl groups. European patent EP 253 567 relates to soil-release polymers that have a molar mass of from 900 to 9,000 and consist of ethylene terephthalate and polyethylene oxide terephthalate, wherein the polyethylene glycol units have molecular weights of from 300 to 3,000 and the molar ratio of ethylene terephthalate to polyethylene oxide terephthalate is from 0.6 to 0.95. European patent application EP 272 033 discloses polyesters that are end-capped at least in portions with C₁₋₄ alkyl or acyl functional groups and that have polypropylene terephthalate and polyoxyethylene terephthalate units. European patent EP 274 907 describes sulfoethyl-end-capped soil-release polyesters containing terephthalate. In European patent application EP 357 280, soil-release polyesters having terephthalate, alkylene glycol and poly-C₂₋₄ glycol units are produced by sulfonation of unsaturated end groups.

In a preferred embodiment of the invention, the viscoelastic, solid filling substance according to the invention contains at least one polyester which allows the removal of dirt, containing the structural units EI to E-III or EI to E-IV,

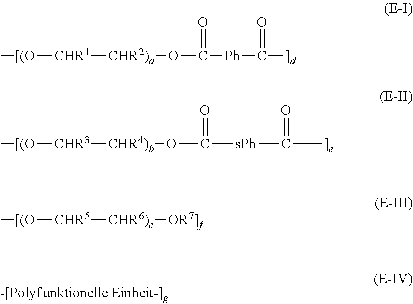

in which
a, b and c each represent, independently of one another, a number from 1 to 200,
d, e and f each represent, independently of one another, a number from 1 to 50,
g represents a number from 0 to 5,
Ph is a 1,4-phenylene functional group,
sPh represents a 1,3-phenylene functional group substituted with a —SO₃M group in position 5,
M represents Li, Na, K, Mg/2, Ca/2, Al/3, ammonium, mono-, di-, tri- or tetraalkylammonium, the alkyl function groups of the ammonium ions being C₁-C₂₂ alkyl functional groups or C₂-C₁₀ hydroxyalkyl functional groups or any desired mixtures thereof,
R¹, R², R³, R⁴, R⁵ and R⁶ each represent, independently of one another, hydrogen or a C₁-C₁₈ n- or iso-alkyl group,
R⁷ represents a linear or branched C₁-C₃₀ alkyl group or a linear or branched C₂-C₃₀ alkenyl group, a cycloalkyl group having 5 to 9 carbon atoms, a C₆-C₃₀ aryl group or a C₆-C₃₀ arylalkyl group, and

Polyfunctional unit represents a unit having 3 to 6 functional groups capable of esterification reaction.

Preference is given to those polyesters in which R¹, R², R³, R⁴, R⁵ and R⁶ are each, independently of one another, hydrogen or methyl, R⁷ represents methyl, a, b and c are each, independently of one another, a number from 1 to 200, in particular 1 to 20, particularly preferably 1 to 5, very preferably a and b=1 and c can be a number from 2 to 10, d is a number between 1 and 25, in particular between 1 and 10, particularly preferably between 1 and 5, e is a number between 1 and 30, in particular between 2 and 15, particularly preferably between 3 and 10, and f is a number between 0.05 and 15, in particular between 0.1 and 10, and particularly preferably between 0.25 and 3. Polyesters of this kind can be obtained, for example, by polycondensation of terephthalic acid dialkyl ester, 5-sulfoisophthalic acid dialkyl ester, alkylene glycols, optionally polyalkylene glycols (where a, b and/or c>1) and polyalkylene glycols capped at one end (corresponding to unit E-III). It should be noted that, for numbers a, b, c>1, there is a polymer backbone and thus the coefficients can assume, as an average, any value within the specified interval. This value reflects the number-average molecular weight. An ester of terephthalic acid having one or more difunctional, aliphatic alcohols is considered as unit (E-I), with ethylene glycol (R¹ and R² each being H) and/or 1,2-propylene glycol (R¹=H and R²=—CH₃ or vice versa) and/or shorter-chain polyethylene glycols and/or poly[ethylene glycol-co-propylene glycol] having number-average molecular weights of from 100 to 2,000 g/mol being preferably used. The structures can contain, for example, 1 to 50 units (E-I) per polymer chain. An ester of 5-sulfoisophthalic acid having one or more difunctional, aliphatic alcohols is considered as unit (E-II), with the above-mentioned esters preferably being used in this case. There can be, for example, 1 to 50 units (E-II) in the structures. Poly[ethylene glycol-co-propylene glycol] monomethyl ethers having average molecular weights of from 100 to 2,000 g/mol and polyethylene glycol monomethyl ethers of general formula CH₃—O—(C₂H₄O)ₙ—H where n=1 to 99, in particular 1 to 20 and particularly preferably 2 to 10, are preferably used as polyalkylene glycol monoalkyl ethers according to unit (E-III) that are nonionically capped at one end. Since the theoretical maximum average molecular weight, to be achieved using quantitative conversion, of a polyester structure is specified by the use of such ethers that are capped at one end, the preferred use amount of structural unit (E-III) is that which is necessary for achieving the average molecular weights described below. With the exception of linear polyesters which result from structural units (E-I), (E-II) and (E-III), the use of crosslinked or branched polyester structures is also in accordance with the invention. This is expressed by the presence of a crosslinking polyfunctional structural unit (E-IV) having at least three to at most 6 functional groups capable of an esterification reaction. Acid, alcohol, ester, anhydride or epoxy groups, for example, can be named as functional groups in this case. Different functionalities in one molecule are also possible. Examples of this are citric acid, malic acid, tartaric acid and gallic acid, particularly preferably 2,2-dihydroxymethylpropionic acid. Polyhydric alcohols such as pentaerythrol, glycerin, sorbitol and/or trimethylolpropane can also be used. These may also be polyvalent aliphatic or aromatic carboxylic acids, such as benzene-1,2,3-tricarboxylic acid (hemimellitic acid), benzene-1,2,4-tricarboxylic acid (trimellitic acid), or benzene-1,3,5-tricarboxylic acid (trimesic acid). The weight proportion of crosslinking monomers, based on the total mass of the polyester, can be up to 10 wt. %, in particular up to 5 wt. %, and particularly preferably up to 3 wt. %, for example. The polyesters, containing the structural units (El), (E-II) and (E-III) and optionally (E-IV), generally have number-average molecular weights in the range of from 700 to 50,000 g/mol, it being possible to determine the number-average molecular weight by means of size-exclusion chromatography in aqueous solution, using calibration with reference to closely distributed polyacrylic acid Na salt standards. Preferably, the number-average molecular weights are in the range of from 800 to 25,000 g/mol, in particular from 1,000 to 15,000 g/mol, particularly preferably from 1,200 to 12,000 g/mol. Preferably, solid polyesters having softening points above 40° C. are used according to the invention as a component of the particle of the second type; said polyesters preferably have a softening point of between 50 and 200° C., particularly preferably between 80° C. and 150° C., and extremely preferably between 100° C. and 120° C. The polyesters can be synthesized according to known processes, for example by the above-mentioned components first being heated at normal pressure by adding a catalyst and then forming the required molecular weights in the vacuum by hyperstoichiometric amounts of the glycols used being distilled off. The known transesterification and condensation catalysts, such as titanium tetraisopropylate, dibutyltin oxide, alkaline or alkaline earth metal alcoholates, or antimony trioxide/calcium acetate, are suitable for the reaction. Reference is made to EP 442 101 for further details.

The viscoelastic, solid filling substance according to the invention can additionally contain at least one enzyme as a washing or cleaning agent. In principle, all the enzymes found in the prior art for textile treatment can be used in this regard. This at least one enzyme is preferably one or more enzymes which can develop catalytic activity in a surfactant-containing liquor, in particular a protease, amylase, lipase, cellulase, hemicellulase, mannanase, pectin-cleaving enzyme, tannase, xylanase, xanthanase, ß-glucosidase, carrageenanase, perhydrolase, oxidase, oxidoreductase and mixtures thereof. Preferred hydrolytic enzymes include in particular proteases, amylases, in particular α-amylases, cellulases, lipases, hemicellulases, in particular pectinases, mannanases, ß-glucanases, and mixtures thereof. Proteases, amylases and/or lipases and mixtures thereof are particularly preferred, and proteases are very particularly preferred. These enzymes are in principle of natural origin; starting from the natural molecules, variants that have been improved for use in washing or cleaning agents are available, which are preferably used accordingly.

Among the proteases, the subtilisin-type proteases are preferred. Examples of these are the subtilisins BPN′ and Carlsberg, the protease PB92, the subtilisins 147 and 309, the alkaline protease from Bacillus lentus, the subtilisin DY, and the enzymes thermitase, proteinase K and proteases TW3 and TW7, which belong to the subtilases but no longer to the subtilisins in the narrower sense. Subtilisin Carlsberg is available in a developed form under the trade name Alcalase® from Novozymes A/S, Bagsvaerd, Denmark. Subtilisins 147 and 309 are marketed by Novozymes under the trade names Esperase® and Savinase®, respectively. The protease variants marketed under the name BLAP® are derived from the protease from Bacillus lentus DSM 5483. Other proteases that can be used are, for example, the enzymes available under the trade names Durazym®, Relase®, Everlase®, Nafizym®, Natalase®, Kannase® and Ovozyme® from Novozymes, the enzymes available under the trade names Purafect®, Purafect® OxP, Purafect® Prime, Excellase® and Properase® from Genencor, the enzyme available under the trade name Protosol® from Advanced Biochemicals Ltd., Thane, India, the enzyme available under the trade name Wuxi® from Wuxi Snyder Bioproducts Ltd., China, the enzymes available under the trade names Proleather® and Protease P® from Amano Pharmaceuticals Ltd., Nagoya, Japan, and the enzyme available under the name Proteinase K-16 from Kao Corp., Tokyo, Japan. Also, the proteases from Bacillus gibsonii and Bacillus pumilus are particularly preferably used.

Examples of amylases that can be used according to the invention are α-amylases from Bacillus licheniformis, from B. amyloliquefaciens or from B. stearothermophilus, as well as the developments thereof that have been improved for use in washing or cleaning agents. The enzyme from B. licheniformis is available from Novozymes under the name Termamyl® and from Genencor under the name Purastar®ST. Development products of this α-amylase are available from Novozymes under the trade names Duramyl® and Termamyl®ultra, from Genencor under the name Purastar®OxAm, and from Daiwa Seiko Inc., Tokyo, Japan, as Keistase®. The α-amylase from B. amyloliquefaciens is marketed by Novozymes under the name BAN®, and derived variants from the α-amylase from B. stearothermophilus are marketed under the names BSG® and Novamyl®, also by Novozymes. Furthermore, for this purpose the α-amylases from Bacillus sp. A 7-7 (DSM 12368) and cyclodextrin glucanotransferase (CGTase) from B. agaradherens (DSM 9948) are to be emphasized. Fusion products of all mentioned molecules can also be used. Furthermore, the developments of the α-amylase from Aspergillus niger and A. oryzae, available under the trade name Fungamyl® from Novozymes, are suitable. Other commercial products that can advantageously be used are, for example, Amylase-LT®, and Stainzyme® or Stainzyme Ultra® or Stainzyme Plus®, the latter also from Novozymes. Variants of these enzymes that can be obtained by point mutations may also be used according to the invention.

Examples of lipases or cutinases that can be used according to the invention, which are contained in particular due to their triglyceride-cleaving activities, but also in order to produce peracids in situ from suitable precursors, are the lipases that can be originally obtained or developed from Humicola lanuginosa (Thermomyces lanuginosis), in particular those with the amino acid exchange D96L. These are marketed for example by Novozymes under the trade names Lipolase®, Lipolase®Ultra, LipoPrime®, Lipozyme® and Lipex®. Furthermore, the cutinases that have been isolated originally from Fusarium solani pisi and Humicola insolens can be used, for example. Lipases that can also be used are available from Amano under the names Lipase CE®, Lipase P®, Lipase B®, and Lipase CES®, Lipase AKG®, Bacillus sp. Lipase®, Lipase AP®, Lipase M-AP® and Lipase AML®. From Genencor, the lipases or cutinases of which the starting enzymes have been isolated originally from Pseudomonas mendocina and Fusarium solanii can be used, for example. The preparations M1 Lipase® and Lipomax® originally marketed by Gist-Brocades, the enzymes marketed by Meito Sangyo KK, Japan, under the names Lipase MY-30®, Lipase OF® and Lipase PL®, and the product Lumafast® from Genencor should be mentioned as other important commercial products.

Depending on their purpose, cellulases can be present as pure enzymes, as enzyme preparations or in the form of mixtures in which the individual components are advantageously complementary in terms of their different performance aspects, in particular in portion packs for textile washing. These performance aspects include in particular the contributions of the cellulase to the primary washing performance of the agent (cleaning performance), to the secondary washing performance of the agent (anti-redeposition effect or graying inhibition), to softening (fabric effect), or to providing a “stone-washed” effect. A usable fungal cellulase preparation that is rich in endoglucanase (EG) and the developments thereof are provided by Novozymes under the trade name Celluzyme®. The products Endolase® and Carezyme®, also available from Novozymes, are based on 50 kD-EG and 43 kD-EG, respectively, from H. insolens DSM 1800. Other commercial products from this company that can be used are Cellusoft®, Renozyme® and Celluclean®. It is also possible to use, for example, 20 kD-EG from Melanocarpus, which are available from AB Enzymes, Finland under the trade names Ecostone® and Biotouch®. Further trade products from AB Enzymes are Econase® and Ecopulp®. Other suitable cellulases are from Bacillus sp. CBS 670.93 and CBS 669.93, wherein those from Bacillus sp. CBS 670.93 are available from Genencor under the trade name Puradax®. Other commercial products from Genencor are “Genencor detergent cellulase L” and IndiAge®Neutra. Variants of these enzymes that can be obtained by point mutations may also be used according to the invention. Particularly preferred cellulases are Thielavia terrestris cellulase variants, cellulases from Melanocarpus, in particular Melanocarpus albomyces, EGIII-type cellulases from Trichoderma reesei, or variants that can be obtained therefrom.

Furthermore, other enzymes which can be grouped together under the term “hemicellulases” can be used in particular to remove specific problematic stains on the substrate. These include, for example, mannanases, xanthan lyases, xanthanases, xyloglucanases, xylanases, pullulanases, pectin-cleaving enzymes, and β-glucanases. The β-glucanase obtained from Bacillus subtilis is available from Novozymes under the name Cereflo®. Hemicellulases that are particularly preferred according to the invention are mannanases which are marketed, for example, under the trade names Mannaway® by Novozymes or Purabrite® by Genencor.

In the context of the present invention, the pectin-cleaving enzymes also include enzymes having the names pectinase, pectate lyase, pectin esterase, pectin demethoxylase, pectin methoxylase, pectin methylesterase, pectase, pectin methylesterase, pectinesterase, pectin pectyl hydrolase, pectin depolymerase, endopolygalacturonase, pectolase, pectin hydrolase, pectin polygalacturonase, endopolygalacturonase, poly-α-1,4-galacturonide, glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase, or exopolygalacturanosidase. Examples of enzymes that are suitable in this regard are available for example under the names Gamanase®, Pektinex AR®, X-Pect® or Pectaway® from Novozymes, under the names Rohapect UF®, Rohapect TPL®, Rohapect PTE100®, Rohapect MPE®, Rohapect MA plus HC, Rohapect DA12L®, Rohapect 10L®, Rohapect B1L® from AB Enzymes, and under the name Pyrolase® from Diversa Corp., San Diego, Calif., USA.

Of all these enzymes, particularly preferred are those which have been stabilized in a comparatively stable manner against oxidation or by means of point mutagenesis, for example. This includes in particular the aforementioned commercial products Everlase® and Purafect®OxP as examples of proteases of this kind and Duramyl® as an example of an α-amylase of this kind.

The viscoelastic, solid filling substance according to the invention contains enzymes preferably in total amounts of from 1×10⁻⁸ to 5 wt. % based on active protein. Preferably, the enzymes are contained in a total amount of from 0.001 to 2 wt. %, more preferably from 0.01 to 1.5 wt. %, even more preferably from 0.05 to 1.25 wt. %, and particularly preferably from 0.01 to 0.5 wt. %.

The use of builder substances (builders) such as silicates, aluminum silicates (particularly zeolites), salts of organic di- and polycarboxylic acids, as well as mixtures of these substances, preferably water-soluble builder substances, can be advantageous.

In an embodiment that is preferred according to the invention, the use of phosphates (including polyphosphates) is largely or completely omitted. In this embodiment, the viscoelastic, solid filling substance according to the invention preferably contains less than 5 wt. %, particularly preferably less than 3 wt. %, in particular less than 1 wt. %, phosphate(s). Particularly preferably, the viscoelastic, solid filling substance according to the invention is, in this embodiment, completely phosphate-free, i.e., the compositions contain less than 0.1 wt. % phosphate(s).

The builders include in particular carbonates, citrates, phosphonates, organic builders, and silicates. The proportion by weight of the total builders with respect to the total weight of the viscoelastic, solid composition according to the invention is preferably from 15 to 80 wt. % and in particular 20 to 70 wt. % for dishwashing detergents.

Some examples of organic builders that are suitable according to the invention are the polycarboxylic acids (polycarboxylates) that can be used in the form of their sodium salts, polycarboxylic acids being understood as those carboxylic acids that carry more than one, in particular two to eight, acid functions, preferably two to six, in particular two, three, four, or five acid functions in the entire molecule. As polycarboxylic acids, dicarboxylic acids, tricarboxylic acids, tetracarboxylic acids, and pentacarboxylic acids, in particular di-, tri-, and tetracarboxylic acids, are thus preferred. The polycarboxylic acids can also carry additional functional groups such as hydroxyl or amino groups, for example. For example, these include citric acid, adipic acid, succinic acid, glutaric acid, malic acid, tartaric acid, maleic acid, fumaric acid, saccharic acids (preferably aldaric acids, for example galactaric acid and glucaric acid), aminocarboxylic acids, in particular aminodicarboxylic acids, aminotricarboxylic acids, aminotetracarboxylic acids such as nitrilotriacetic acid (NTA), glutamic-N,N-diacetic acid (also called N,N-bis(carboxymethyl)-L-glutamic acid or GLDA), methyl glycine diacetic acid (MGDA) and derivatives thereof and mixtures thereof. Preferred salts are the salts of the polycarboxylic acids such as citric acid, adipic acid, succinic acid, glutaric acid, tartaric acid, GLDA, MGDA, and mixtures thereof.

Other substances that are suitable as organic builders are polymeric polycarboxylates (organic polymers with a plurality of (in particular greater than ten) carboxylate functions in the macromolecule), polyaspartates, polyacetals, and dextrins.

Besides their building effect, the free acids also typically have the property of an acidification component. Particularly noteworthy here are citric acid, succinic acid, glutaric acid, adipic acid, gluconic acid, and any mixtures thereof.

Particularly preferred viscoelastic, solid filling substances according to the invention contain one or more salts of citric acid, i.e., citrates, as one of their substantial builders. These are contained in the viscoelastic, solid filling substances according to the invention (in particular for washing textiles) preferably in a proportion of 0.3 to 10 wt. %, in particular from 0.5 to 8 wt. %, particularly from 0.7 to 6.0 wt. %, particularly preferably 0.8 to 5.0 wt. %, based in each case on the total weight of the filling substance. One or more salts of citric acid are contained in the viscoelastic, solid filling substances according to the invention (in particular for cleaning hard surfaces, in particular for washing dishes), preferably in a proportion of from 2 to 40 wt. %, in particular from 5 to 30 wt. %, more particularly from 7 to 28 wt. %, particularly preferably from 10 to 25 wt. %, very particularly preferably from 15 to 20 wt. %, in each case relative to the total weight of the composition.

The viscoelastic, solid filling substances according to the invention can contain, in particular, phosphonates as a further builder. A hydroxy alkane and/or amino alkane phosphonate is preferably used as a phosphonate compound. Of the hydroxy alkane phosphonates, 1-hydroxyethane-1,1-diphosphonate (HEDP) has particular significance. Possible preferable aminoalkane phosphonates include ethylenediamine tetramethylene phosphonate (EDTMP), diethylenetriamine pentamethylene phosphonate (DTPMP) and the higher homologues thereof. Phosphonates are preferably contained in viscoelastic, solid filling substances according to the invention in amounts of from 0.1 to 10 wt. %, in particular in amounts of from 0.5 to 8 wt. %, very particularly preferably from 2.5 to 7.5 wt. %, in each case relative to the total weight of the composition.

The combined use of citrate, (hydrogen) carbonate and phosphonate is particularly preferred (particularly for use in dishwashing agents). These can be used in the aforementioned quantities. In particular, amounts of from 10 to 25 wt. % citrate, 10 to 30 wt. % carbonate (or hydrogen carbonate), and 2.5 to 7.5 wt. % phosphonate are used in this combination in the viscoelastic, solid filling substances according to the invention, in each case based on the total weight of the composition.

Additional particularly preferred viscoelastic, solid filling substances according to the invention, in particular for use as washing or cleaning agents, preferably as dishwashing agents, more preferably as automatic dishwashing agents, are characterized in that, in addition to citrate and (hydrogen) carbonate and, in some cases, phosphonate, they contain at least one additional phosphorus-free builder. In particular, it is selected from aminocarboxylic acids, the additional phosphorus-free builder preferably being selected from methyl glycine diacetic acid (MGDA), glutamic acid diacetate (GLDA), aspartic acid diacetate (ASDA), hydroxyethyliminodiacetate (HEIDA), iminodisuccinate (IDS), and ethylenediamine disuccinate (EDDS), particularly preferably from MGDA or GLDA. An example of a particularly preferred combination is citrate, (hydrogen) carbonate, and MGDA as well as, optionally, phosphonate.

The proportion by weight of the additional phosphorous-free builder, in particular of the MGDA and/or GLDA, is preferably from 0 to 40 wt. %, in particular from 5 to 30 wt. %, more particularly from 7 to 25 wt. %. The use of MGDA or GLDA, in particular MGDA, is particularly preferred as granular material. Advantageous in this regard are MGDA granules that contain as little water as possible and/or have a lower hygroscopicity (water absorption at 25° C., normal pressure) than non-granulated material powders. The combination of at least three, in particular at least four builders from the above group has proven to be advantageous for the cleaning and rinsing performance of portion packs according to the invention, in particular portion packs for use as dishwashing agents, preferably automatic dishwashing agents. Besides those, additional builders can also be contained.

Polymeric polycarboxylates are also suitable as organic builders. These are, for example, the alkali metal salts of polyacrylic acid or polymethacrylic acid, for example those having a relative molecular mass of from 500 to 70,000 g/mol. Suitable polymers are in particular polyacrylates which preferably have a molecular mass of from 1,000 to 20,000 g/mol. Due to their superior solubility, the short-chain polyacrylates, which have molar masses of from 1,100 to 10,000 g/mol, and particularly preferably from 1,200 to 5,000 g/mol, can in turn be preferred from this group.

Viscoelastic, solid filling substances according to the invention can also contain, as a builder, crystalline layered silicates of general formula NaMSiₓO₂ₓ₊₁.y H₂O, where M represents sodium or hydrogen, x is a number from 1.9 to 22, preferably from 1.9 to 4, with 2, 3, or 4 being particularly preferred values for x, and y represents a number from 0 to 33, preferably from 0 to 20. It is also possible to use amorphous sodium silicates with a modulus Na₂O:SiO₂ of 1:2 to 1:3.3, preferably of 1:2 to 1:2.8 and in particular of 1:2 to 1:2.6, which are preferably delayed in dissolution and have secondary washing properties.

An optical brightener is preferably selected from the substance classes of distyrylbiphenyls, stilbenes, 4,4′-diamino-2,2′-stilbene disulfonic acids, coumarins, dihydroquinolones, 1,3-diarylpyrazolines, naphthalic acid imides, benzoxazole systems, benzisoxazole systems, benzimidazole systems, pyrene derivatives substituted with heterocycles, and mixtures thereof.

Particularly preferred optical brighteners include disodium-4,4′-bis-(2-morpholino-4-anilino-s-triazin-6-ylamino)stilbene disulfonate (for example available as Tinopal® DMS from BASF SE), disodium-2,2′-bis-(phenyl-styryl)disulfonate (for example available as Tinopal® CBS from BASF SE), 4,4′-bis[(4-anilino-6-[bis(2-hydroxyethyl)amino]-1,3,5-triazin-2-yl)amino]stilbene-2,2′-disulfonic acid (for example available as Tinopal® UNPA from BASF SE), hexasodium-2,2′-vinylenebis[(3-sulphonato-4,1-phenylene)imino[6-(diethylamino)-1,3,5-triazin-4,2-diyl]imino]bis-(benzene-1,4-disulfonate) (for example available as Tinopal® SFP from BASF SE), 2,2′-(2,5-thiophendiyl)bis[5-1,1-dimethylethyl)-benzoxazole (for example available as Tinopal® SFP from BASF SE) and/or 2,5-bis(benzoxazol-2-yl)thiophene.

It is preferable for the dye transfer inhibitor to be a polymer or a copolymer of cyclic amines such as vinylpyrrolidone and/or vinylimidazole. Polymers suitable as a dye transfer inhibitor include polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride, polyethylene glycol-modified copolymers of vinylpyrrolidone and vinylimidazole, and mixtures thereof. Particularly preferably, polyvinylpyrrolidone (PVP), polyvinylimidazole (PVI) or copolymers of vinylpyrrolidone and vinylimidazole (PVP/PVI) are used as a dye transfer inhibitor. The polyvinylpyrrolidones (PVP) used preferably have an average molecular weight of 2,500 to 400,000 and are commercially available from ISP Chemicals as PVP K 15, PVP K 30, PVP K 60 or PVP K 90, or from BASF as Sokalan® HP 50 or Sokalan® HP 53. The copolymers of vinylpyrrolidone and vinylimidazole (PVP/PVI) used preferably have a molecular weight in the range of from 5,000 to 100,000. A PVP/PVI copolymer is commercially available from BASF under the name Sokalan® HP 56, for example. Other dye transfer inhibitors that can be extremely preferably used are polyethylene glycol-modified copolymers of vinylpyrrolidone and vinylimidazole, which for example are available from BASF under the name Sokalan® HP 66.

In the scope of a preferred embodiment according to the invention, the viscoelastic, solid filling substance according to the invention contains solid particles (also referred to as particles in the following). Such dispersed solid particles are to be understood as solid substances which do not dissolve in the liquefied phase of the filling substance according to the invention and are present as a separate phase at temperatures of up to 5° C. units above the sol-gel temperature of the viscoelastic and solid filling substance according to the invention. During the production of the viscoelastic filling substances according to the invention, these particles are suspended in the liquid phase above the sol-gel temperature and then the liquid phase is cooled below the sol-gel temperature to obtain the viscoelastic filling substance according to the invention.

The solid particles are preferably selected from polymers, pearlescing pigments, microcapsules, speckles, bleaching agents (for example sodium percarbonate), or mixtures thereof.

Within the meaning of the present invention, microcapsules include any type of capsule known to a person skilled in the art, but in particular core-shell capsules and matrix capsules. Matrix capsules are porous molded bodies that have a structure similar to a sponge. Core-shell capsules are molded bodies that have a core and a shell. Capsules that have an average diameter X_{50.3} (volume average) of from 0.1 to 200 preferably from 1 to 100 more preferably from 5 to 80 particularly preferably from 10 to 50 μm and in particular from 15 to 40 μm are suitable as microcapsules. The average particle size diameter X_{50.3} is determined by sieving or by means of a Camsizer particle size analyzer from Retsch.

The microcapsules of the invention preferably contain at least one active ingredient, preferably at least one odorant. These preferred microcapsules are perfume microcapsules.

In a preferred embodiment of the invention, the microcapsules have a semi-permeable capsule wall (shell).

A semi-permeable capsule wall within the meaning of the present invention is a capsule wall that is semi-permeable, i.e. continuously releases small quantities of the capsule core over time, without the capsules e.g. being destroyed or opened e.g. by tearing. These capsules continuously release small quantities of the active ingredient contained in the capsule, e.g. perfume, over a long period of time.

In another preferred embodiment of the invention, the microcapsules have an impermeable shell. An impermeable shell within the meaning of the present invention is a capsule wall that is substantially not permeable, i.e. releases the capsule core only by the capsule being damaged or opened. These capsules contain significant quantities of the at least one odorant in the capsule core, and therefore when the capsule is damaged or opened, a very intense fragrance is provided. The fragrance intensities thus achieved are generally so high that lower quantities of the microcapsules can be used in order to achieve the same fragrance intensity as for conventional microcapsules.

In a preferred embodiment of the invention, the viscoelastic, solid filling substance according to the invention contains both microcapsules having a semipermeable shell and microcapsules having an impermeable shell. By using both types of capsule, a significantly improved fragrance intensity can be provided over the entire laundry cycle.

In another preferred embodiment of the invention, the surfactant composition according to the invention may also contain two or more different microcapsule types having semipermeable or impermeable shells.

High-molecular compounds are usually considered as materials for the shell of the microcapsules, such as protein compounds, for example gelatin, albumin, casein and others, cellulose derivatives, for example methylcellulose, ethylcellulose, cellulose acetate, cellulose nitrate, carboxymethylcellulose and others, and especially also synthetic polymers such as polyamides, polyethylene glycols, polyurethanes, epoxy resins and others. Preferably, melamine formaldehyde polymer, melamine urea polymer, melamine urea formaldehyde polymer, polyacrylate polymer or polyacrylate copolymer are used as the wall material, i.e. as the shell. Capsules according to the invention are for example, but not exclusively, described in US 2003/0125222 A1, DE 10 2008 051 799 A1 or WO 01/49817.

Preferred melamine formaldehyde microcapsules are produced by melamine formaldehyde precondensates and/or the C₁-C₄ alkyl ethers thereof in water, by the at least one odor modulator compound and optionally other ingredients, such as at least one odorant, being condensed in the presence of a protective colloid. Suitable protective colloids are e.g. cellulose derivatives, such as hydroxyethyl cellulose, carboxymethyl cellulose and methylcellulose, polyvinylpyrrolidone, copolymers of N-vinylpyrrolidone, polyvinyl alcohols, partially hydrolyzed polyvinyl acetates, gelatin, arabic gum, xanthan gum, alginates, pectins, degraded starches, casein, polyacrylic acid, polymethacrylic acid, copolymerisates of acrylic acid and methacrylic acid, sulfonic acid group-containing water-soluble polymers having a content of sulfoethyl acrylate, sulfoethyl methacrylate or sulfopropyl methacrylate, and polymerisates of N-(sulfoethyl)-maleinimide, 2-acrylamido-2-alkyl sulfonic acids, styrene sulfonic acids and formaldehyde and condensates of phenol sulfonic acids and formaldehyde.

It is preferable for the surface of the microcapsules used according to the invention to be coated entirely or in part with at least one cationic polymer. Accordingly, at least one cationic polymer from polyquaternium-1, polyquaternium-2, polyquaternium-4, polyquaternium-5, polyquaternium-6, polyquaternium-7, polyquaternium-8, polyquaternium-9, polyquaternium-10, polyquaternium-11, polyquaternium-12, polyquaternium-13, polyquaternium-14, polyquaternium-15, polyquaternium-16, polyquaternium-17, polyquaternium-18, polyquaternium-19, polyquaternium-20, polyquaternium-22, polyquaternium-24, polyquaternium-27, polyquaternium-28, polyquaternium-29, polyquaternium-30, polyquaternium-31, polyquaternium-32, polyquaternium-33, polyquaternium-34, polyquaternium-35, polyquaternium-36, polyquaternium-37, polyquaternium-39, polyquaternium-43, polyquaternium-44, polyquaternium-45, polyquaternium-46, polyquaternium-47, polyquaternium-48, polyquaternium-49, polyquaternium-50, polyquaternium-51, polyquaternium-56, polyquaternium-57, polyquaternium-61, polyquaternium-69 or polyquaternium-86 is suitable as a cationic polymer for coating the microcapsules. Polyquaternium-7 is very particularly preferred. The polyquaternium nomenclature used in the scope of the present application for the cationic polymers is taken from the declaration for cationic polymers according to the International Nomenclature of Cosmetic Ingredients (INCI declaration) for cosmetic raw materials.

Microcapsules that can preferably be used have an average diameter X_{50.3} in the range of 1 to 100 μm, preferably from 5 to 95 μm, in particular from 10 to 90 μm, for example from 10 to 80 μm.

The shell of the microcapsules surrounding the core or (filled) cavity preferably has an average thickness in the range of from approximately 5 to 500 nm, preferably of from approximately 50 nm to 200 nm, in particular of from approximately 70 nm to approximately 180 nm.

Pearlescing pigments are pigments that have a pearlescent shine. Pearlescing pigments consist of thin sheets that have a high refraction index, and partially reflect the light and are partially transparent to the light. The pearlescent shine is generated by interference of the light hitting the pigment (interference pigment). Pearlescing pigments are usually thin sheets of the above-mentioned material, or contain the above-mentioned material as thin, multilayered films or as components arranged in parallel in a suitable carrier material.

The pearlescing pigments that can be used according to the invention are either natural pearlescing pigments such as fish silver (guanine/hypoxanthine mixed crystals from fish scales) or mother of pearl (from ground seashells), monocrystalline, sheet-like pearlescing pigments such as bismuth oxychloride and pearlescing pigments with a mica base and a mica/metal oxide base. The latter pearlescing pigments are mica that has been provided with a metal oxide coating.

Pearlescing pigments with a mica base and mica/metal oxide base are preferred according to the invention. Mica is a phyllosilicate. The most important representatives of these silicates are muscovite, phlogopite, paragonite, biotite, lepidolite, and margarite. In order to produce the pearlescing pigments in conjunction with metal oxides, mica, primarily muscovite or phlogopite, is coated with a metal oxide. Suitable metal oxides are, inter alia, TiO₂, Cr₂O₃, and Fe₂O₃. Interference pigments and colored luster pigments are obtained as pearlescing pigments according to the invention by suitable coating. These pearlescing pigment types additionally have color effects as well as a glittering optical effect. Furthermore, the pearlescing pigments that can be used according to the invention also contain a color pigment that does not derive from a metal oxide.

The grain size of the pearlescing pigments that are preferably used is preferably between 1.0 μm and 100 μm, particularly preferably between 10.0 and 60.0 μm, at an average diameter X_{50.3} (volume average).

Within the meaning of the invention, “speckles” are understood to mean macroparticles, in particular macrocapsules, that have an average diameter X_{50.3} (volume average) of more than 300 μm, in particular from 300 to 1,500 μm, preferably from 400 to 1,000 μm.

Speckles are preferably matrix capsules. The matrix is preferably colored. The matrix is formed for example by gelation, polyanion-polycation interactions or polyelectrolyte-metal ion interactions, and this is well known in the prior art, just like the production of particles using these matrix-forming materials. An example of a matrix-forming material is alginate. For the production of alginate-based speckles, an aqueous alginate solution, optionally also containing the active ingredient or active ingredients to be included, is subject to dripping and is then cured in a precipitation bath containing Ca²⁺ ions or Al³⁺ ions. Alternatively, other matrix-forming materials may be used instead of alginate.

In a preferred embodiment, the viscoelastic, solid filling substances according to the invention, in particular as dishwashing agents, contain, as an additional component, at least one zinc salt as a glass corrosion inhibitor. The zinc salt can be an inorganic or organic zinc salt. The zinc salt to be used according to the invention preferably has a solubility in water of greater than 100 mg/1, preferably greater than 500 mg/1, particularly preferably greater than 1 g/l, and in particular greater than 5 g/l (all solubilities at 20° C. water temperature). The inorganic zinc salt is preferably selected from the group comprising zinc bromide, zinc chloride, zinc iodide, zinc nitrate, and zinc sulfate. The organic zinc salt is preferably selected from the group comprising zinc salts of monomeric or polymeric organic acids, particularly from the group of zinc acetate, zinc acetyl acetonate, zinc benzoate, zinc formiate, zinc lactate, zinc gluconate, zinc ricinoleate, zinc abietate, zinc valerate, and zinc-p-toluene sulfonate. In an embodiment that is particularly preferred according to the invention, zinc acetate is used as a zinc salt. The zinc salt is preferably contained in viscoelastic, solid filling substances according to the invention in an amount of from 0.01 wt. % to 5 wt. %, particularly preferably in an amount of from 0.05 wt. % to 3 wt. %, in particular in an amount of from 0.1 wt. % to 2 wt. %, based on the total weight of the composition. In addition or alternatively to the aforementioned salts (particularly the zinc salts), polyethylene imines such as those which are available under the name Lupasol® (BASF) can preferably be used as glass corrosion inhibitors in an amount of from 0 to 5 wt. %, in particular 0.01 to 2 wt. %.

Examples of viscoelastic, solid filling substances that can be used (particularly for washing agent portion packs) are filling substances F1 to F3 in the following table:

| | F1 | F2 | F3 |
|---|---|---|---|
| | [wt. %] | [wt. %] | [wt. %] |
| C₁₁₋₁₃ alkylbenzene sulfonic acid | 23.0 | 26.0 | 23.0 |
| C₁₃₋₁₅ alkyl alcohol branched at | 24.0 | 27.0 | 24.0 |
| the 2 position, ethoxylated with | | | |
| 8 mol ethylene oxide | | | |
| Glycerin | 9.0 | 9.0 | 9.0 |
| 2-aminoethanol | 6.8 | 6.8 | 6.8 |
| Ethoxylated polyethyleneimine | 5.0 | 5.0 | 5.0 |
| C₁₂₋₁₈ fatty acid | 7.5 | 7.5 | 7.5 |
| Diethylenetriamine- | 0.6 | 0.6 | 0.6 |
| N,N,N′,N′N″-penta | | | |
| (methylenephosphonic acid), | | | |
| heptasodium salt | | | |
| (sodium DTPMP) | | | |
| 1,2-propylene glycol | 4.5 | 4.5 | 4.5 |
| Ethanol | 4.0 | 4.0 | 4.0 |
| Sodium bisulfite | 0.1 | 0.1 | 0.1 |
| Denatonium benzoate | 0.001 | 0.001 | 0.001 |
| Soil-release polymers of | 1.0 | 1.0 | 0.6 |
| ethylene terephthalate and | | | |
| polyethylene oxide terephthalate | | | |
| Copolymer from | — | — | 0.15 |
| N-vinyl pyrrolidone and | | | |
| N-vinylimidazole | | | |
| (dye transfer inhibitor) | | | |
| 1,3:2,4-di-O-benzylidene- | 1.2 | 1.2 | 1.2 |
| D-sorbitol | | | |
| Perfume, dye, protease, | 1.7 | 1.7 | 1.5 |
| amylase, lipase, | | (without | (without |
| cellulase, optical brightener | | dye) | optical |
| | | | brightener) |
| Water | up to 100 | up to 100 | up to 100 |

It is preferred if the portion pack according to the invention contains, as further filling substance, as little free-flowing, granular mixture of a solid composition as possible and the further filling substance is in particular free of free-flowing, granular mixture of a solid composition. A granular mixture is formed from a large number of loose, solid particles, which in turn comprise what are known as grains. A grain is a name for the particulate constituents of powders (grains are the loose, solid particles), dusts (grains are the loose, solid particles), granular material (loose, solid particles are agglomerates of several grains), and other granular mixtures. The free-flowing ability of a granular mixture relates to its ability to flow freely under its own weight out of a flow-test funnel having an outlet of 16.5 mm diameter. A preferred portion pack according to the invention is characterized in that pourable, granular mixture is contained in an amount of 0 to 4 wt. %, in particular from 0 to 3, particularly preferably from 0 to 1 wt. %, very particularly preferably from 0 to 0.5 wt. %, each based on the total weight of all filling substances contained in the portion pack.

Items 1 to 55 below show specific embodiments of the invention. The reference signs of the figures have been given below only for clarification and not to restrict the scope of items 1 to 55:
1. An apparatus (1) for production of a water-soluble shell (2) for holding a filling substance (9), comprising a tank (3) filled with a melt (4) of a shell material (5), wherein the shell material (5) contains a polymer and is water-soluble and is solid under standard conditions, and a male mold (6) movably arranged in the region of the tank (3) and automatically lowerable into the melt (4) and withdrawable from the tank (3), to form, from the shell material (5), a water-soluble shell (2) resting on the male mold (6) (which shell preferably rests on the male mold (6) after the male mold (6) has been removed from the tank (3)).
2. The apparatus (1) according to item 1, wherein the male mold (6) has a temperature regulator.
3. The apparatus (1) according to one of the preceding items, wherein the tank (3) substantially has an inverted shape of the male mold (6).
4. The apparatus (1) according to one of the preceding items, wherein the shell material (5) contains at least one active ingredient.
5. The apparatus (1) according to one of the preceding items, wherein the shell material (5) contains at least one bittering agent, in particular denatonium benzoate.
6. The apparatus (1) according to one of the preceding items, wherein the shell material (5) is elastic (preferably under standard conditions).
7. The apparatus (1) according to one of the preceding items, wherein the melt (4) contains a granular material (7).
8. The apparatus (1) according to item 7, wherein the granular material (7) contains at least one active ingredient.

9. The apparatus (1) according to one of the preceding items, wherein at least one further tank (3b) having at least one further melt (4b) of a further shell material (5b) is provided, wherein the male mold (6) having the shell (2; 2a) resting thereon is automatically lowerable into the further melt (4b) and withdrawable from the further melt (4b) in order to form a further water-soluble shell (2b) resting against the water-soluble shell (2; 2a) resting on the male mold (6).
10. The apparatus (1) according to item 9, wherein the shell materials (5a, 5b) contain different active ingredients and/or the melts (4a, 4b) contain different granular materials (7).
11. The apparatus (1) according to one of items 9 to 10, wherein the shell materials (5a, 5b) have different optical properties in the solid state.
12. The apparatus (1) according to one of the preceding items, wherein one end of the male mold (6) has a portion comprising a filling substance (9).
13. The apparatus (1) according to one of the preceding items, wherein the male mold (6) is designed in such a way that a rigid shell (2) lying thereon cannot be stripped off.
14. The apparatus (1) according to item 13, wherein the male mold (6) is wider in a distal region than in a proximal region.
15. The apparatus (1) according to one of items 13 to 14, wherein the male mold (6) has an unevenness (11).
16. The apparatus (1) according to one of the preceding items, wherein the male mold (6) can be set in vibration.
17. A process for production of a water-soluble shell (2) for holding a filling substance (9), wherein
   an apparatus (1) according to one of items 1 to 16 is provided,
   a melt (4) is produced from shell material (5), wherein the contents of the shell material, which are solid under standard conditions, are preferably comminuted before melting in such a way that a powder with an average particle size X_{50.3} (volume average) of less than 100 μm is present,
   the male mold (6) is lowered into the melt at a temperature below a melting temperature of the melt (4) so that a contact surface of the male mold (6) is covered with shell material (5),
   a shell (2) is formed by solidifying the shell material (5) on the male mold (6), and
   the male mold (6) having a shell (2) adhering to it is lifted out of the tank (3) before, after, or during solidification, and
   the shell (2) is detached from the male mold (3).
18. The process according to item 17, wherein the male mold (6) is lowered into the melt (4) to a depth which is greater than a maximum width of the male mold (6).
19. The process according to one of items 17 or 18, wherein the shell (2) is detached by rolling it out or turning it inside out.
20. The process according to one of items 17 to 19, wherein one end of the male mold (6) has a portion comprising a filling substance (9) and the portion is separated when the shell (2) is detached, so that the shell (2) having the filling substance (9) is replaced.
21. The process according to one of items 17 to 20, wherein the shell (2) is detached under the action of sound waves, in particular ultrasonic waves.
22. The process according to one of items 17 to 21, wherein the shell (2) is cured by hot air drying.
23. The process according to one of items 17 to 22, wherein a layer is vapor-deposited onto the shell (2).
24. The process for production of a portion pack (12) for use as a washing or cleaning agent, comprising the steps that
   a shell (2) is provided by a process according to one of items 17 to 23,
   the shell (2) is filled with at least one viscoelastic and solid filling substance (9), and
   optionally the shell (2) is closed.
25. The process according to item 24, wherein viscoelastic, solid filling substance (9) is formed in the shell (2) by curing a liquid composition introduced into the shell (2).
26. The process according to item 24 or 25, wherein the filling substance (9) contains, based on the total weight of the above-mentioned filling substance (9),
   (i) a total amount of from 0.1 to 70 wt. % of at least one surfactant,
   and
   (ii) a total amount of at least 0.5 wt. % of at least one organic gelator compound with a molar mass <1000 g/mol, a solubility in water of less than 0.1 g/L (20° C.) and a structure containing at least a hydrocarbon structural unit with 6 to 20 carbon atoms (preferably at least one carbocyclic, aromatic structural unit) and additionally an organic structural unit covalently bonded to the aforementioned hydrocarbon unit, which has at least two groups selected from —OH, —NH—, or mixtures thereof
   and
   (iii) optionally water.
27. The process according to item 26, characterized in that the organic gelator compound is selected from benzylidene alditol compound, diketopiperazine compound, dibenzylcystine compound, hydrogenated castor oil, hydroxystearic acid, N—(C₈-C₂₄)-hydrocarbyl glyconamide, or mixtures thereof.
28. A shell (2) for a portion pack (12) suitable for use as a washing or cleaning agent, produced by a process according to one of items 17 to 23.
29. A portion pack (12) for use as a washing or cleaning agent containing
   (a) a shell (2) made from a melt (4) of a polymer-containing and water-soluble shell material (5) which is solid under standard conditions, and
   (b) a viscoelastic and solid filling substance (9) in the above-mentioned shell (2), containing, based on the total weight of said filling substance (9),
      (i) a total amount of from 0.1 to 70 wt. % of at least one surfactant,
      and
      (ii) a total amount of at least 0.5 wt. % of at least one organic gelator compound with a molar mass <1000 g/mol, a solubility in water of less than 0.1 g/L (20° C.) and a structure containing at least a hydrocarbon structural unit with 6 to 20 carbon atoms (preferably at least one carbocyclic, aromatic structural unit) and additionally an organic structural unit covalently bonded to the aforementioned hydrocarbon unit, which has at least two groups selected from —OH, —NH—, or mixtures thereof
      and
      (iii) optionally water.
30. The portion pack (12) according to item 29, characterized in that at least one polymer is contained as a polymer of the shell material, selected from (optionally acetalized) polyvinyl alcohol (PVOH), copolymers of polyvinyl alcohol, polyvinyl pyrrolidone, polyethylene oxide, gelatin, cellulose, and the derivatives thereof, acrylic acid-containing polymers, polyacrylamides, oxazoline polymers, polystyrene sulfonates, polyurethanes, polyesters, polyethers, and mixtures thereof, preferably from (optionally acetalized) polyvinyl alcohol (PVOH), copolymers of polyvinyl alcohol, polyethylene oxide, gelatin, and mixtures thereof.
31. The portion pack (12) according to one of items 29 or 30, characterized in that the shell (2) additionally contains at least one bitter substance, in particular denatonium benzoate.
32. The portion pack (12) according to one of items 29 to 31, characterized in that the shell (2) is produced by a process according to one of items 24 to 27.
33. The portion pack (12) according to one of items 29 to 32, characterized in that the above-mentioned at least one filling substance (9) has a storage modulus of between 10³ Pa and 10⁸ Pa, preferably between 10⁴ Pa and 10⁸ Pa and a loss modulus (in each case at 20° C., with a deformation of 0.1% and a frequency of 1 Hz), and the storage modulus in the frequency range between 10⁻² Hz and 10 Hz is at least twice as great as the loss modulus, preferably five times greater than the loss modulus, particularly preferably at least ten times greater than the loss modulus.
34. The portion pack (12) according to one of items 29 to 33, characterized in that the storage modulus of the above-mentioned at least one filling substance (9) is in a range from 10⁵ Pa to 10⁷ Pa.
35. The portion pack (12) according to one of items 29 to 34, characterized in that the organic gelator compound is selected from benzylidene alditol compound, diketopiperazine compound, dibenzylcystine compound, hydrogenated castor oil, hydroxystearic acid, N—(C₅-C₂₄)-hydrocarbyl glyconamide, or mixtures thereof
36. The portion pack (12) according to one of items 29 to 35, characterized in that the above-mentioned at least one filling substance (9) contains at least one benzylidene alditol compound of the formula (I) as the organic gelator compound

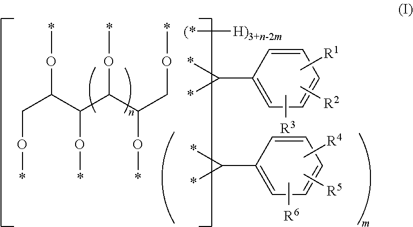

wherein
*- represents a covalent single bond between an oxygen atom of the alditol backbone and the provided functional group,
n represents 0 or 1, preferably 1,
m represents 0 or 1, preferably 1,
R¹, R², and R³ represent, independently of one another, a hydrogen atom, a halogen atom, a C₁-C₄ alkyl group, a cyano group, a nitro group, an amino group, a carboxyl group, a hydroxy group, a —C(═O)—NH—NH₂ group, a —NH—C(═O)—(C₂-C₄-alkyl) group, a C₁-C₄ alkoxy group, a C₁-C₄ alkoxy C₂-C₄ alkyl group, with two of the functional groups forming together with the remainder of the molecule a 5-membered or 6-membered ring,
R⁴, R⁵, and R⁶ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, a —NH—C(═O)—(C₂-C₄-alkyl) group, a C₁-C₄ alkoxy group, a C₁-C₄ alkoxy C₂-C₄ alkyl group, with two of the functional groups forming, together with the remainder of the molecule, a 5-membered or 6-membered ring.
37. The portion pack (12) according to item 36, characterized in that the alditol backbone according to formula (I) is derived from D-glucitol, D-mannitol, D-arabinitol, D-ribitol, D-xylitol, L-glucitol, L-mannitol, L-arabinitol, L-ribitol, or L-xylitol.
38. The portion pack (12) according to one of items 36 or 37, characterized in that R¹, R², R³, R⁴, R⁵ and R⁶ are, independently of one another, a hydrogen atom, methyl, ethyl, chlorine, fluorine, or methoxy, preferably a hydrogen atom.
39. The portion pack (12) according to one of items 29 to 38, characterized in that the above-mentioned at least one filling substance (9) contains at least one benzylidene alditol compound of the formula (I-1) as the organic gelator compound

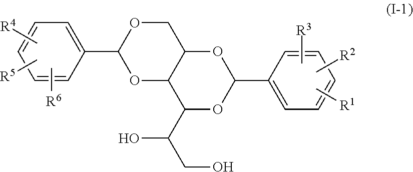

where R¹, R², R³, R⁴, R⁵ and R⁶ are as defined in item 36.
40. The portion pack (12) according to one of items 29 to 39, characterized in that the above-mentioned filling substance, as the organic gelator compound, is at least one benzylidene alditol compound from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-Di-O-(2,4-dimethylbenzylidene)-D-sorbitol; 1,3:2,4-di-O-(p-ethylbenzylidene)-D-sorbitol; 1,3:2,4-Di-O-(3,4-dimethylbenzylidene)-D-sorbitol, or mixtures thereof.
41. The portion pack (12) according to one of items 29 to 40, characterized in that, the organic gelator compound is contained in a total amount of 0.5 to 10.0 wt. %, in particular 0.8 to 5.0 wt. %, more preferably 1.0 wt. % and 4.5 wt. %, very particularly preferably 1.0 and 4.0 wt. %, based on the total weight of the viscoelastic and solid filling substance.
42. The portion pack (12) according to one of items 29 to 41, characterized in that, water is contained in the above-mentioned at least one filling substance (9) in a total amount of 0 to 25 wt. %, in particular from 0 to 20 wt. %, more preferably from 0 to 15 wt. %, based on the total weight of the above-mentioned at least one filling substance (9).
43. The portion pack (12) according to one of items 29 to 42, characterized in that the above-mentioned at least one filling substance (9) additionally contains at least one organic solvent having a molecular weight of at most 500 g/mol (preferably selected from (C₂-C₈) alkanols having at least one hydroxyl group (particularly preferably ethanol, ethylene glycol, 1,2-propanediol, glycerin, 1,3-propanediol, n-propanol, isopropanol, 1,1,1-trimethylolpropane, 2-methyl-1,3-propanediol, 2-hydroxymethyl-1,3-propanediol), triethylene glycol, butyl diglycol, polyethylene glycols having a weight-average molar mass M_{w} of at most 500 g/mol, glycerol carbonate, propylene carbonate, 1-methoxy-2-propanol, 3-methoxy-3-methyl-1-butanol, butyl lactate, 2-isobutyl-2-methyl-4-hydroxymethyl-1,3-dioxolane, 2,2-dimethyl-4-hydroxymethyl-1,3-dioxolane, dipropylene glycol, or mixtures thereof).
44. The portion pack (12) according to item 43, characterized in that the above-mentioned organic solvent is contained in the above-mentioned at least one filling substance (9) in a total amount of 5 to 40 wt. %, in particular of 10 up to 35 wt. %, based on the total weight of the above-mentioned at least one filling substance (9).
45. The portion pack (12) according to one of items 29 to 44, characterized in that in the above-mentioned filling substance, at least one anionic surfactant, preferably at least one anionic surfactant is contained selected from the group consisting of C₈₋₁₈ alkyl benzene sulfonates, olefin sulfonates, C₁₂₋₁₈ alkane sulfonates, ester sulfonates, alkyl sulfates, alkenyl sulfates, fatty alcohol ether sulfates, and mixtures thereof.
46. The portion pack (12) according to one of items 29 to 45, characterized in that the above-mentioned filling substance contains at least one anionic surfactant of the formula (T-1),

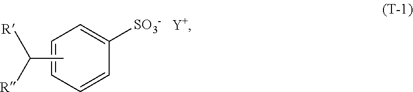

where
R′ and R″ are, independently of one another, H or alkyl, and together contain 9 to 19, preferably 9 to 15 and in particular 9 to 13, C atoms, and Y⁺ is a monovalent cation or the nth part of an n-valent cation (in particular Na⁺).
47. The portion pack (12) according to one of items 29 to 45, characterized in that the above-mentioned filling substance contains at least one nonionic surfactant.
48. The portion pack (12) according to one of items 29 to 45, characterized in that the above-mentioned filling substance contains at least one nonionic surfactant of the formula (T-2)

R²—O—(XO)ₘ—H, (T-2)
where
R² represents a linear or branched C₈-C₁₈ alkyl group, an aryl group or an alkyl aryl group,
XO represents, independently of one another, an ethylene oxide (EO) group or a propylene oxide (PO) group,
m represents integers of from 1 to 50.
49. The portion pack (12) according to one of items 29 to 48, characterized in that surfactant is contained in the above-mentioned filling substance in a total amount of 5 to 70 wt. %, more preferably 5 to 65 wt. %, more preferably 5 to 60 wt. %, more preferably 10 to 70 wt. %, more preferably 10 to 65 wt %, more preferably 10 to 60 wt %, more preferably 15 to 70 wt %, more preferably 15 to 65 wt %, more preferably 15 to 60 wt %, particularly preferably 20 to 70 wt. %, more preferably 20 to 65 wt. %, more preferably 20 to 60 wt. %, very particularly preferably 25 to 70 wt. %, more preferably 25 to 65 wt. %, more preferably 25 to 60 wt. %, further preferably 30 to 70 wt. %, more preferably 30 to 65 wt. %, more preferably 30 to 60 wt. %.
50. The portion pack (12) according to one of items 29 to 49, characterized in that surfactant is contained in the above-mentioned filling substance in a total amount of 0.1 to 5.0 wt. %, in particular 0.2 to 4.0 wt. %, based on the total weight of said filling substance.
51. The portion pack (12) according to one of items 29 to 50, characterized in that the above-mentioned at least one filling substance (9) is in the form of a molded body.
52. The portion pack (12) according to item 51, characterized in that the molded body has a weight of at least 1 g, particularly preferably at least 5 g, very particularly preferably from 10 to 30 g.
53. The portion pack (12) according to one of items 29 to 52, characterized in that it is water-soluble.
54. The portion pack (12) according to one of items 29 to 53, characterized in that the above-mentioned filling substance is transparent.
55. The portion pack (12) according to one of items 29 to 54, characterized in that, based on the total weight of all filling substances contained in the portion pack, free-flowing, granular mixture is contained in an amount of 0 to 4 wt. %, in particular 0 to 3, particularly preferably from 0 to 1 wt. %.

For a configuration of the portion pack for use as a washing agent, the above items 1 to 49 and 51 to 55 are particularly preferred.

For a configuration of the portion pack for use as a dishwashing agent, the above items 1 to 44, 47, 48 and 51 to 54 are particularly preferred.

The invention is not restricted to the embodiments mentioned above. Deviations from this are also conceivable. For example, any number of male molds, for example arranged in parallel, can be provided. The portion pack can also be sealed by closure with a form-fitting cover, for example made from the shell material.

### LIST OF REFERENCE SIGNS

1 apparatus
2 shell
3 tank
4 melt
5 shell material
6 male mold
7 granulate
8 end of male mold
9 filling substance
10 parting surface
11 unevenness
12 portion pack for use as a washing or cleaning agent
13 cover
101-108 steps

What is claimed is:

1. An apparatus for production of a water-soluble shell for holding a filling substance, comprising a tank filled with a melt of a shell material, wherein the shell material contains a polymer and is water-soluble and is solid under standard conditions, and a male mold movably arranged in the region of the tank and automatically lowerable into the melt and withdrawable from the tank in order to form a water-soluble shell from the shell material.

2. The apparatus according to claim 1, wherein the male mold has a temperature regulator.

3. The apparatus according to claim 1, wherein the tank substantially has an inverted shape of the male mold.

4. The apparatus according to claim 1, wherein the male mold, which is movably arranged in the region of the tank, is automatically lowerable into the melt and withdrawable from the tank in order to remove it from the shell material to form a water-soluble shell resting on the male mold.

5. The apparatus according to claim 1, wherein at least one further tank having at least one further melt of a further shell material is provided, wherein the male mold having the shell resting thereon is automatically lowerable into the further melt and withdrawable from the further melt in order to form a further water-soluble shell resting against the water-soluble shell resting on the male mold.

6. The apparatus according to claim 5, wherein the shell materials have different optical properties in the solid state.

7. The apparatus according to claim 1, wherein one end of the male mold has a portion comprising a filling substance.

8. The apparatus according to claim 1, wherein the male mold is designed in such a way that a rigid shell lying thereon cannot be stripped off.

9. The apparatus according to claim 8, wherein the male mold is wider in a distal region than in a proximal region.

10. The apparatus according to claim 8, wherein the male mold has an unevenness.

11. The apparatus according to claim 8, wherein the male mold can be set in vibration.

12. A process for production of a water-soluble shell for holding a filling substance, wherein
an apparatus according to claim 1 is provided,
the male mold is lowered into the melt at a temperature below a melting temperature of the melt so that a contact surface of the male mold is covered with shell material,
a shell is formed by solidifying the shell material on the male mold, and
the male mold having a shell adhering to it is lifted out of the tank before, after, or during solidification, and
the shell is detached from the male mold.

13. The process according to claim 12, wherein the male mold is lowered into the melt to a depth which is greater than a maximum width of the male mold.

14. The process according to claim 12, wherein the shell is detached by rolling it out or turning it inside out.

15. The process according to claim 12, wherein one end of the male mold has a portion comprising a filling substance and the portion is separated when the shell is detached, so that the shell having the filling substance is replaced.

16. A shell for a portion pack suitable for use as a washing or cleaning agent, produced by a process according to claim 12.

17. A portion pack as a washing or cleaning agent containing
(a) a shell made from a melt of a polymer-containing and water-soluble shell material which is solid under standard conditions, and
(b) a viscoelastic and solid filling substance in the above-mentioned shell, containing, based on the total weight of said filling substance,
(i) a total amount from 0.1 to 70 wt. % of at least one surfactant,
and
(ii) a total amount of at least 0.5 wt. % of at least one organic gelator compound having a molar mass of <1000 g/mol, a solubility in water of less than 0.1 g/L (20° C.), and a structure containing at least one hydrocarbon structural unit having 6 to 20 carbon atoms, and, in addition, an organic structural unit covalently bonded to the aforementioned hydrocarbon unit, which has at least two groups selected from —OH, —NH—, or mixtures thereof,
and
(iii) optionally water.

18. The portion pack according to claim 17, wherein the above-mentioned at least one filling substance has a storage modulus of between 10³ Pa and 10⁸ Pa and a loss modulus (in each case at 20° C., with a deformation of 0.1% and a frequency of 1 Hz), and the storage modulus in the frequency range between 10⁻² Hz and 10 Hz is at least twice as great as the loss modulus.

19. The portion pack according to claim 17, wherein the organic gelator compound is selected from benzylidene alditol compound, diketopiperazine compound, dibenzylcystine compound, hydrogenated castor oil, hydroxystearic acid, N—(C₈-C₂₄)-hydrocarbyl glyconamide, or mixtures thereof.
